(19) United States
(12) Patent Application Publication
(10) Pub. No.: US 2026/0089198 A1
(43) Pub. Date: Mar. 26, 2026

(54) SYSTEMS AND METHODS FOR CAPTURING AND DISTRIBUTING A LIVE AUDIO OR MULTI-MEDIA STREAM OF A LIVE EVENT IN REAL-TIME

(71) Applicant: ProWire Sport LLC, Wilmington, DE (US)

(72) Inventors: Adam Toner, Wilmington, DE (US); Rhod Davies, Wilmington, DE (US)

(73) Assignee: ProWire Sport LLC, Wilmington, DE (US)

(21) Appl. No.: 19/120,759

(22) PCT Filed: Oct. 12, 2023
(86) PCT No.: PCT/US2023/076658

§ 371 Date: Apr. 11, 2025

Related U.S. Application Data
(60) Provisional application No. 63/415,443, filed on Oct. 12, 2022.

(51) Int. Cl. H04L 65/611; H04L 65/70; H04L 65/75; H04N 21/2187

(52) U.S. Cl. CPC H04L 65/611; H04L 65/70; H04L 65/765; H04N 21/2187

(57) ABSTRACT

Systems and methods for capturing and distributing livestreams of a live event in real-time to a plurality of mobile computing devices are described. According to some embodiments, the system comprises a memory device configured to store computer-executable instructions that when executed causes a processing device to, upon receipt of the livestream via a first network: generate, in real-time, discrete audio data packets from the livestream; generate a transmission copy of each discrete audio data packet; and transmit the transmission copies one-at-a-time to a provider processing device. The provider processing device is configured to, in accordance with an associated transmission policy, transmit each received transmission copy over a provider network for receipt by the mobile computing devices one-at-a-time. Methods and systems for establishing UDP communication between devices are also

### CROSS-REFERENCE TO RELATED APPLICATIONS

The present application claims priority from U.S. Provisional Patent Application No. 63/415,443 filed on Oct. 12, 2022, the contents being incorporated herein by reference.

### FIELD

The specification relates generally to the transmission of a live audio stream, and specifically to systems and methods for capturing and distributing a live audio stream of a live event in real-time to a plurality of mobile computing devices.

### BACKGROUND

Audio streaming is commonly used by radio stations and music streaming services to distribute audio material over the Internet. These services are optimized to provide good quality audio while latency is deemed to be less important. Even “live” radio programs that are streamed over the Internet typically have several seconds of latency from source to end listener.

The Internet is a vast network of networks, owned by many different entities including government, private companies and academic institutions. Network segments vary in speed and capacity, and data packets may take a multitude of different routes through those networks dependent upon the type of data in the packet and network conditions at that instant in time. Such mechanisms usually result in significant latency or delay between the time the audio data is received at the server (or associated audio input device(s)) and the time the audio data is received at the audio client device from the server.

### BRIEF DESCRIPTIONS OF THE DRAWINGS

For a better understanding of the various implementations or embodiments described herein and to show more clearly how they may be carried into effect, reference will now be made, by way of example only, to the accompanying drawings in which:

FIG. 1 depicts a schematic diagram of certain aspects of known audio data streaming systems and methods;

FIG. 2 depicts a schematic diagram of certain aspects of known audio data streaming systems and methods;

FIG. 3 depicts an example system for capturing and distributing a live audio or multi-media stream of a live event in real-time to a plurality of mobile computing devices, according to non-limiting embodiments;

FIG. 4 depicts another example system for capturing and distributing a live audio or multi-media stream of a live event in real-time to a plurality of mobile computing devices, according to non-limiting embodiments;

FIG. 5 depicts an example buffer holding a discrete audio or multi-media data packet generated from a live audio or multi-media stream, according to non-limiting embodiments;

FIG. 6 depicts an example copy of a discrete audio or multi-media data packet generated from a live audio or multi-media stream, according to non-limiting embodiments;

FIG. 7 depicts another example system for capturing and distributing a live audio or multi-media stream of a live event in real-time to a plurality of mobile computing devices, according to non-limiting embodiments;

FIG. 8 depicts an example method for capturing and distributing a live audio or multi-media stream of a live event in real-time to a plurality of mobile computing devices, according to non-limiting embodiments;

FIG. 9 depicts an example system for establishing UDP communication between computing devices, according to non-limiting embodiments; and

FIGS. 10 and 11 depict an example method for establishing UDP communication between a client processing device associated with a first network and a processing device associated with a second network.

### DETAILED DESCRIPTION

Herein described are systems and methods for capturing and distributing a live audio stream of a live event in real-time to a plurality of mobile computing devices. It will be appreciated that for simplicity and clarity of illustration, where considered appropriate, reference numerals may be repeated among the figures to indicate corresponding or analogous elements. In addition, numerous specific details are set forth in order to provide a thorough understanding of the exemplary aspects or embodiments of the present application described herein. However, it will be understood by those of ordinary skill in the art that the exemplary aspects or embodiments described herein may be practiced without these specific details. In other instances, well-known methods, procedures and components have not been described in detail so as not to obscure the exemplary aspects or embodiments described herein. Also, the description is not to be considered as limiting the scope of the exemplary aspects or embodiments described herein. Any systems, method steps, method blocks, components, parts of components, and the like described herein in the singular are to be interpreted as also including a description of such systems, method steps, components, parts of components, and the like in the plural, and vice versa.

It will also be understood that for the purposes of this application, “at least one of X, Y, and Z” or “one or more of X, Y, and Z” language can be construed as X only, Y only, Z only, or any combination of two or more items X, Y, and Z (e.g., XYZ, XYY, YZ, ZZ).

In the present application, components may be described as being “configured to” or “enabled to” perform one or more functions. Generally, it is understood that a component that is configured to or enabled to perform a function is configured to or enabled to perform the function, or is suitable for performing the function, or is adapted to perform the function, or is operable to perform the function, or is otherwise capable of performing the function.

Generally, the described systems and methods are typically suitable for use at live events, such as sporting events, in large venues, such as sports stadia or convention centres. One or more computing devices, such as servers, are used to stream live audio to the audience members at the venue via their respective mobile computing devices. Audience members can receive the audio stream on their own mobile phone or another mobile computing device. According to some embodiments, the described system and methods are suitable for use with streaming of live events at venues remote from where the live event takes place. For example, according to some embodiments, the live event takes place at an arena and the audio or multi-media of the live event is being streamed to mobile device(s) remote from the arena (such as, for example, the home of a user of one of the mobile devices) receiving the stream.

The audio or multi-media being streamed typically relates directly to the live event in progress in the venue. For example, according to some embodiments, live audio is captured from an athlete or referee (via at least one audio input device, such as a microphone worn by the athlete or referee) as they participate in a sports match. The audience member can listen via the mobile computing device to what is being said on the field of play as they watch the action.

Latency or delay is a particularly important consideration in distributing a live audio stream of a live event in a venue. The audio stream relates to live action happening in view of the audience, so it is particularly important to the listening audience member that the audio and live action appear to be synchronized. If there is too much delay between what the audience sees and what they hear then the effect will tend to be distracting and may ruin the experience. Persons skilled in the art will appreciate that end-to-end latencies up to and including 500 milliseconds (mS) are generally considered “real-time”. However, the amount of delay that can be tolerated depends upon what the audience members can see and hear. For example, if the audience can see a player's or a commentator's lips moving while they are talking then generally an audio delay, or end-to-end latency, of more than 45 mS is usually problematic. If the audience members are further away, so that they cannot see the lips moving, then a delay, or end-to-end latency, of 100 to 500 mS may be an acceptable user experience.

To minimize the end-to-end latency between the audio source and the mobile computing device clients, while supporting a large number of mobile computing device clients, the described systems and methods tend to optimize the audio path through the distributing computing devices for low latency, low Central Processing Unit (CPU) load and/or low memory footprint.

In addition, some major sports venues can accommodate up to 100,000, or more, spectators, and so embodiments of the system must also support a very large number of mobile client devices. According to some embodiments of the systems and methods described herein, the load can be spread over multiple servers, such that each server is capable of supporting thousands of concurrent users.

Given the prevalence of cellular and other entity-dedicated network infrastructure, systems and methods that can distribute captured live audio or multi-media devices using that infrastructure while minimizing latency would be advantageous. However, existing cellular or other entity-dedicated network infrastructure is not necessarily designed for the specific purpose of providing low latency live audio or multi-media streams to mobile devices in a venue (e.g., the geographic location of the nearest cellular tower or radio access network (RAN) node may not be in venue). In addition, there may be situations in which a client mobile device would like to receive the live audio or multi-media stream of a live event taking place in the same venue as that event and/or of a live event taking place in another venue. For example, a user of a client mobile device attending a live event at venue A may also want to receive live audio or multi-media streams from events taking place at the same time at venues B and C which may not be geographically co-incident (e.g., venue A is in a geographically different location than venue B and/or C). As discussed further below, the described systems and methods are configured to utilize cellular or other entity-dedicated network infrastructure (such as a cellular provider network) to provide a live audio or multi-media stream of a live event in real-time to a plurality of devices with reduced latency.

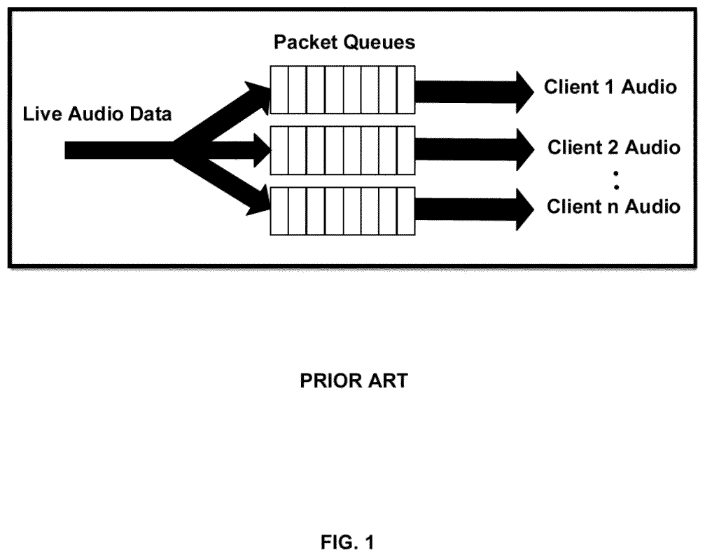

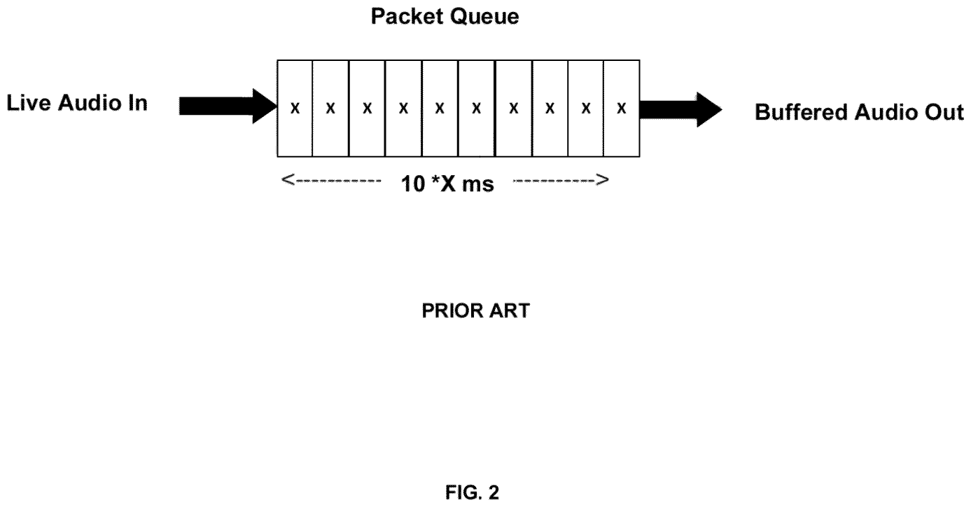

Attention is directed to FIGS. 1 and 2, which are schematic diagrams depicting how audio data is processed in a typical audio streaming system. As shown in FIGS. 1 and 2, the typical server creates an output data queue for each connected client device. This allows the end client device to pause and or seek within the audio stream without affecting any other client device of the system. For example, if one client device pauses the audio stream, it should not pause for all other connected client devices.

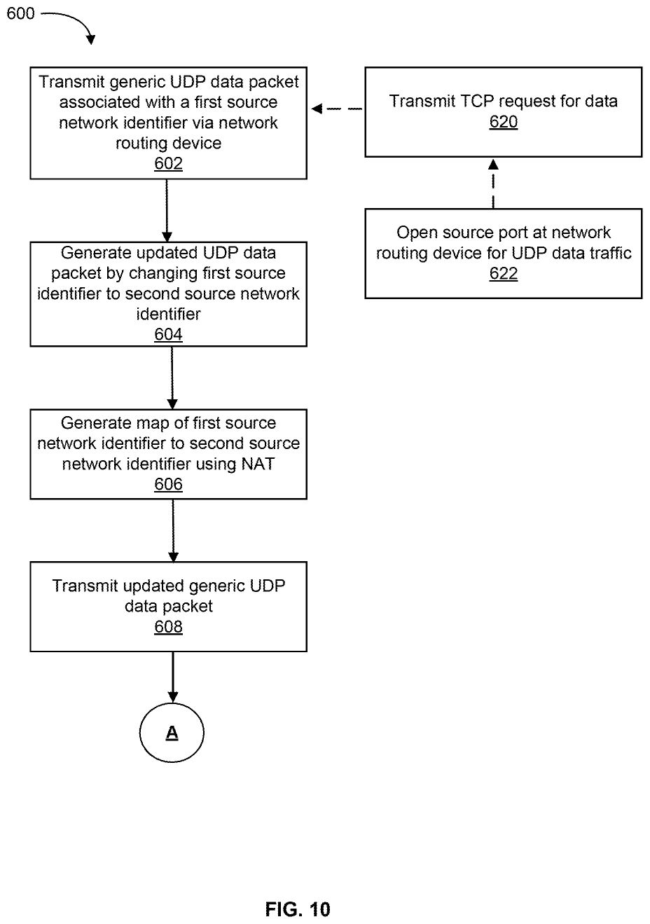

Such data packet queues require a significant amount of memory to implement, and each requires CPU time to manage. The CPU and memory requirement limit the number of concurrent client devices that can be supported by a single server. They also add latency to the audio stream, since each data packet stored on the queue adds another packet time to the end-to-end delay. In the example shown in FIGS. 2, 10 packets of X mS each are queued, producing 10*X mS of latency between the time the live audio data is captured at a connected audio device and is transmitted to the client devices (such as to Client 1 Audio, Client 2 Audio to Client n Audio in FIG. 1). As illustrated in FIG. 2, the latency increases as the packet queues increase. In contrast, the described systems capture and distribute a live audio stream in real-time and so there is little or no provision for pausing or seeking within the audio stream.

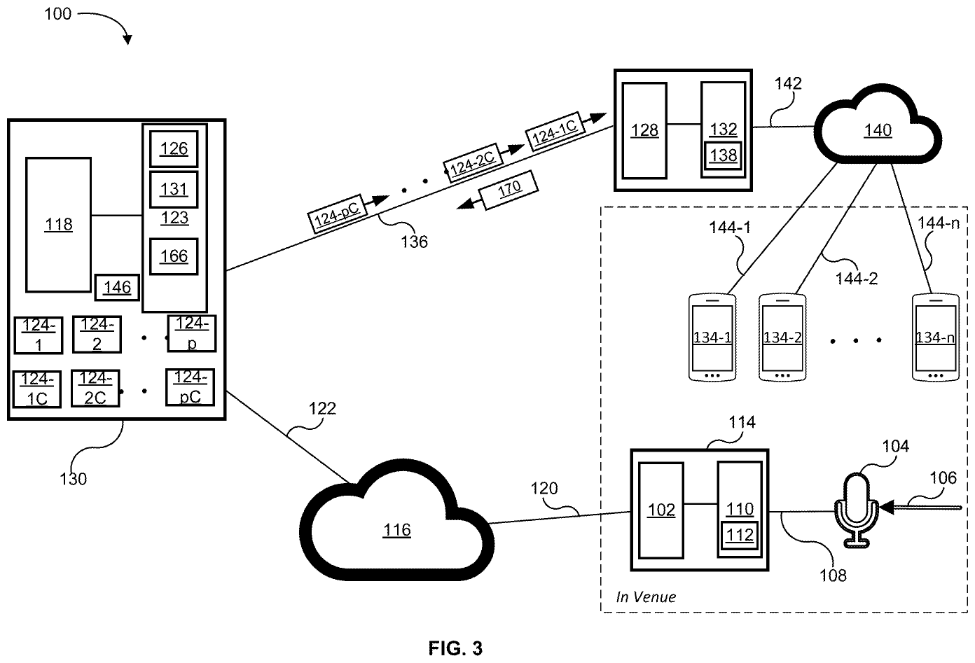

Attention is directed to FIG. 3, which depicts example system 100 for capturing and distributing a live audio or multi-media stream of a live event in real-time to a plurality of mobile computing devices. System 100 comprises a first processing device 102 coupled to at least one audio or multi-media input device, such as audio input device 104. Although one audio or multi-media input device is depicted, according to some embodiments, system 100 comprises a plurality of audio or multi-media input devices. Audio input device 104 is any suitable audio and/or multi-media input device, such as a wired or wireless microphone or video camera worn by a referee of the live event. Audio input device 104 (or audio input devices 104) is situated in the venue of the live event and receives, in real-time, a live audio or multi-media stream 106 (also referred to herein as live stream 106) from the live event. According to some embodiments, audio input device 104 (or audio input devices 104) are situated outside of the venue of the live event, such as radio station or broadcast facility. For example, according to some embodiments, the live stream 106 comprises a live audio signal that conveys, for example, a referee's voice. Although the exemplary systems and methods described herein describe the capturing and distribution of a live audio stream, it is understood that the systems and methods may also be utilized to capture and distribute a live multi-media stream that comprises audio data and video data or a live video stream that comprises video data (without audio data).

As noted above, audio input device 104 is coupled to first processing device 102. For example, first processing device 102 may be configured to communicate with audio input device 104 over communication link 108 such that first processing device 102 is enabled to receive live stream 106 from the audio device 104. Communication link 108 comprises any suitable wired and/or wireless communication link(s), or suitable combination thereof. First processing device 102 may also be configured to communicate with audio input device 104 in accordance with any suitable protocol or protocols, such as wired or wireless data protocols, WiFi protocols, WiMax protocols, and/or a combination. As used herein, the terms “processing device”, “processing devices”, “processing device(s)”, “processor”, “processors” or “processor(s)” may refer to any combination of processing devices, and the like, suitable for carrying out the actions or methods described herein. For example, first processing device 102 may comprise any suitable processing device, or combination of processing devices, including but not limited to a microprocessor, a central processing unit (CPU) and the like. Other suitable processing devices are also within the scope of the application.

First processing device 102 is coupled to first memory device 110. First memory device 110 can comprise any suitable memory device, including but not limited to any suitable one of, or combination of, a local and/or remote volatile memory, non-volatile memory, random access memory (RAM), read-only memory (ROM), hard drive, optical drive, buffer(s), cache(s), flash memory, magnetic computer storage devices (e.g. hard disks, floppy disks, and magnetic tape), optical memory ((e.g., CD(s) and DVD(s)), and the like. Other suitable memory devices are also within the scope of the application. As such, it is understood that the term “memory”, or any variation thereof, as used herein may comprise a tangible and non-transitory computer-readable medium (i.e., a medium which does not comprise only a transitory propagating signal per se) comprising or storing computer-executable instructions, such as computer programs, sets of instructions, code, software, and/or data for execution of any method(s), step(s) or process(es) described herein by any processing device(s) and/or microcontroller(s) described herein. First memory device 110 is configured to store first computer-executable instructions 112 for execution by first processing device 102.

In FIG. 3, first processing device 102 and first memory device 110 are depicted as co-located on first computing device 114. First computing device 114 may comprise one or more computing devices, such as one or more servers, desktop computers and mobile computing devices. According to some embodiments, first processing device 102 and first memory device 110 are not located on the same computing device. For example, according to some embodiments, first computing device 114 comprises two or more servers in wired and/or wireless communication with each other, and first processing device 102 is located on one of the servers while first memory 110 is located on another one of the two or more computing devices. According to some embodiments, first processing device 102 and first memory 110 are located remotely from the venue hosting the live event.

In accordance with first computer-executable instructions 112, first processing device 102 is enabled to receive live stream 106 via the at least one audio or multi-media device(s) 104 in real-time. The received live stream 106 may be in analog and/or digital format. According to some embodiments, if the received live stream 106 is in analog format (i.e., an analog signal), then first processing device 102, in accordance with first computer-executable instructions 112, is enabled to convert the received live stream 106 into a digital format. According to some embodiments, first processing device 102 is configured to compress live stream 106 using a suitable low latency audio and/or multi-media codec, such as G.711, MP3 or Opus.

In accordance with first computer-executable instructions 112, first processing device 102 is further enabled to transmit, over a first network (such as first network 116), the received live stream 106 for receipt by a second processing device or second processing devices, such as second processing device 118. For example, first processing device 102 may be in communication with second processing device 118 to transmit data over first network 116 via communication links 120 and 122. Communication links 120 and 122 comprise any suitable wired and/or wireless communication link(s), or suitable combination thereof. First processing device 102 may also be configured to transmit and receive data over first network 116 according to any suitable protocol or protocols, such as wired or wireless data protocols, cellular device protocols, WiFi protocols, WiMax protocols, Real-Time Transport Protocol (RTP) and/or a combination of protocols. According to some embodiments, first network 116 is a local area network (LAN) of the venue hosting the live event. According to some embodiments, the first network 116 is a wireless network. According to some embodiments, the first network 116 is a cellular network. According to some embodiments, first network 116 is a dedicated fiber network. According to some embodiments, first network 116 is the Internet.

According to some embodiments, first processing device 102 is further enabled to, in accordance with first computer-executable instructions 112, encode received live stream 106 in accordance with the User Datagram Protocol (UDP) or any other suitable protocol prior to transmission of the live stream 106 to second processing device 118.

The described systems and methods may include additional features for added security. For example, according to some embodiments, first processing device 102 is further enabled to, in accordance with first computer-executable instructions 112, encrypt received live stream 106 in accordance with any suitable encryption protocol prior to transmission of live stream 106 to second processing device 118. According to some embodiments, data is encrypted prior to transmission from any of the devices and/or modules described herein.

As noted above, example system 100 comprises second processing device 118. Second processing device 118 may be configured to communicate with first processing device 102 and third processing device 128 (described further below) using any suitable protocol or protocols, such as wired or wireless data protocols, cellular device protocols, WiFi protocols, WiMax protocols, and/or a combination thereof. Second processing device 118 may comprise any suitable processing device, or combination of processing devices, including but not limited to a microprocessor, a central processing unit (CPU) and the like. Any other suitable processing devices are also within the scope of the application. Second processing device 118 is in remote communication with first processing device 102. For example, as shown in FIG. 3, second processing device 118 is in communication with first processing device 102 via first network 116 (which, as noted above, may be a network of the venue).

Second processing device 118 is coupled to second memory device 123. Second memory device 123 is configured to store second computer-executable instructions 126 for execution by second processing device 118. Second memory device 123 can comprise any suitable memory device, including but not limited to any suitable one of, or combination of, a local and/or remote volatile memory, non-volatile memory, random access memory (RAM), read-only memory (ROM), hard drive, optical drive, buffer(s), cache(s), flash memory, magnetic computer storage devices (e.g. hard disks, floppy disks, and magnetic tape), optical memory ((e.g., CD(s) and DVD(s)), and the like. Other suitable memory devices are also within the scope of the application.

In accordance with second computer-executable instructions 126, upon receipt of live stream 106, or data representative of live stream 106, second processing device 118 is enabled to: generate, in real-time, a plurality of discrete audio or multi-media data packets, such as data packets 124-1, 124-2. 124-p (collectively, data packets 124) from live stream 106; generate a transmission copy of each one of the plurality of discrete data packets, such as transmission copies 124-1C, 124-2C. 124-pC (collectively, transmission copies 124C); and, transmit the generated transmission copies 124C one-at-a-time for receipt by third processing device 128 (FIG. 3). For example, second processing device 118 is enabled to transmit transmission copy 124-1C of data packet 124-1 before transmitting transmission copy 124-2C of data packet 124-2, and so on. According to some embodiments, transmission copies 124 are encrypted prior to transmission to third processing device 128.

In FIG. 3, second processing device 118 and second memory device 123 are depicted as being co-located on computing device 130. Computing device 130 may comprise one or more computing devices, such as one or more servers, desktop computers and mobile computing devices. According to some embodiments, second processing device 118 and second memory device 123 are not located on the same computing device. For example, according to some embodiments, example computing device 130 comprises two or more servers in wired and/or wireless communication with each other, and second processing device 118 is located on one of the servers while second memory device 123 is located on another one of the two or more computing devices.

System 100 further comprises third processing device 128. Third processing device 128 is configured to communicate with second processing device 118 using any suitable protocol or protocols, such as wired or wireless data protocols, WiFi protocols, WiMax protocols, cellular device protocols, Real-Time Transport Protocol (RTP) and/or a combination thereof. For example, third processing device 128 may be enabled to communicate with second processing device 118 via one or more communication links, such as communication link 136. Communication link 136 comprises any suitable wired or wireless communication link(s), or suitable combination thereof.

Third processing device 128 may comprise any suitable processing device, or combination of processing devices, including but not limited to a microprocessor, a central processing unit (CPU) and the like. Any other suitable processing devices are also within the scope of the application. As shown in FIG. 3, third processing device 128 is remote from first processing device 102 (i.e., not in direct communication with first processing device 102, at least according to some embodiments). According to some embodiments, third processing device 128 can be co-located with second processing device 130.

Third processing device 128 is also configured to transmit data over second network 140 to a plurality of mobile computing devices, such as mobile computing devices 134-1, 134-2 to 134-n (collectively, mobile computing devices 134). For example, third processing device 128 may be in communication with mobile computing devices 134 to transmit data over second network 140 via communication links 142 and 144-1 to 144-n (communications links 144-1 to 144-n referred to collectively as communication links 144). Communication links 142 and 144 comprise any suitable wired and/or wireless communication link(s), or suitable combination thereof. Third processing device 128 may also be configured to transmit and receive data over the second network 140 according to any suitable protocol or protocols, such as wired or wireless data protocols, cellular device protocols, WiFi protocols, WiMax protocols, Real-Time Transport Protocol (RTP) and/or a combination of protocols. According to some embodiments, third processing device 128 is associated with a cellular carrier or other mobile network operator and second network 140 is a cellular carrier network or a subsystem network, such as a Radio Access Network (RAN) of the cellular carrier or other mobile network operator. According to some embodiments, second network 140 comprises a cloud RAN (C-RAN). As such, mobile computing devices 134 may be mobile devices registered or otherwise granted access to the cellular carrier network. Any suitable cellular network is contemplated by this application. For example, according to some embodiments, second network 140 is an LTE, 4G, 5G or 6G network.

According to some embodiments, third processing device 128 is further enabled to encrypt the received transmission copies 124C, or any associated data, prior to transmission for receipt by mobile computing devices 134.

Although second processing device 118 and third processing device 128 are depicted as separate devices in the figures, it is understood that the functionality of second processing device 118 and third processing device 128 described herein may be performed using a combination of one or more processing devices and one or more modules. For example, according to some embodiments, the functionality of computing device 130, including second processing device 118 executing second computer-executable instructions 126, is provided by a software/hardware module or a plurality of software/hardware modules associated with third processing device 128. For example, such software/hardware module(s) may be embodied as one or more virtual machines hosted by or otherwise associated with the third processing device 128.

Mobile computing devices 134 are any computing devices suitable for communicating with third processing device 128 over second network 140 and for outputting received audio data to users of the mobile computing devices 134. For example, mobile computing devices 134 may be one or more tablet computing devices, laptop computing devices, PDAs (personal digital assistants), cellphones, smartphones and computer terminals having at least one suitable audio output device. In addition, the mobile computing devices 134 are configured to subscribe to the live stream 106. For example, according to some embodiments, second processing device 118 is in communication with a Real-Time Streaming Protocol (RTSP) media manager 146. According to some embodiments, second processing device 118 is configured to accept incoming media session requests from mobile devices 134, such as request 170, via RTSP media manager 146. For example, according to some embodiments, mobile devices 134 send request 170 to RTSP media manager 146 via third network 140 and third processing device 128 (i.e., request 170 is routed through third processing device 128 for receipt by RTSP media manager 146) (FIG. 3). The RTSP media manager 146 accepts incoming session requests from the mobile computing devices 134 (requests to access to the live stream 106 via first processing device 102) using the RTSP to commence or stop access to the live stream 106 for any of the mobile computing devices 134. According to some embodiments, a list 131 of subscribing mobile computing devices is maintained at second memory 123 or another storage medium accessible by second processing device 118. According to some embodiments, the list 131 is updated periodically. According to some embodiments, the list 131 is continuously updated.

Third processing device 128 is coupled to third memory device 132. Third memory device 132 can comprise any suitable memory device, including but not limited to any suitable one of, or combination of, a local and/or remote volatile memory, non-volatile memory, random access memory (RAM), read-only memory (ROM), hard drive, optical drive, buffer(s), cache(s), flash memory, magnetic computer storage devices (e.g. hard disks, floppy disks, and magnetic tape), optical memory (e.g., CD(s) and DVD(s)), and the like. Any other suitable memory devices are also within the scope of the application. Third memory device 132 is configured to store third computer-executable instructions 138 for execution by third processing device 128.

In accordance with third computer-executable instructions 138, as each transmission copy (such as transmission copy 124-1) is received from second processing device 118, third processing device 128 is enabled to transmit that received copy over second network 140 for receipt by mobile computing devices 134 prior to transmitting another received transmission copy for receipt by mobile computing devices 134. For example, third processing device 128 is configured to transmit transmission copy 124-1 to mobile computing devices 134 prior to transmitting transmission copy 124-2 mobile computing devices 134. According to some embodiments, the transmission of transmission copies by third processing device 128 is in accordance with a transmission policy associated with second processing device 118, such as transmission policy 166 (FIG. 3).

According to some embodiments, the transmission of transmission copies by second processing device 118 or third processing device 128 is via Web RTC or another suitable real-time communication protocol. According to some embodiments, the transmission of transmission copies by second processing device 118 or third processing device 128 is initiated or established using a session traversal of UDP through network address translators server (Session Traversal Utilities for NAT (STUN) server). According to some embodiments, the transmission of transmission copies by second processing device 118 or third processing device 128 is via a traversal using relays around NAT server (Traversal Using Relays around NAT (TURN) server). According to some embodiments, the transmission of transmission copies by second processing device 118 or third processing device 128 is preceded by a generic UDP packet to establish a connection between the second processing device 118 or third processing device 128 and mobile computing devices 134. According to some embodiments, the transmission of transmission copies by second processing device 118 or third processing device 128 is preceded by a generic UDP packet to establish a connection between the media manager 146 and mobile computing devices 134. According to some embodiments, each transmission copy transmitted by the second-processing device 118 or third-processing device 128 is preceded by a generic UDP packet to establish a connection between the third processing device 128 and mobile computing devices 134. According to some embodiments, each transmission copy transmitted by the second-processing device 118 or third processing device 128 is preceded by a generic UDP packet to establish a connection between the media manager 146 and mobile computing devices 134. For example, according to some embodiments, the generic UDP data packet is transmitted from one or more of mobile computing devices 134 for receipt by second processing device 118. According to some embodiments, the transmission of transmission copies by the second processing device 118 or third-processing device 128 is preceded by a signal or “handshake” between the second processing device 118 or third processing device 128 and mobile computing devices 134. According to some embodiments, the transmission of transmission copies by the second processing device 118 or third processing device 128 is preceded by a signal or “handshake” between the media manager 146 and mobile computing devices 134. According to some embodiments, each transmission copy transmitted by the second processing device 118 or third processing device 128 is preceded by a signal or “handshake” between the second processing device 118 or third processing device 128 and mobile computing devices 134. According to some embodiments, each transmission copy transmitted by the second processing device 118 or third-processing device 128 is preceded by a signal or “handshake”between the media manager 146 and mobile computing devices 134.

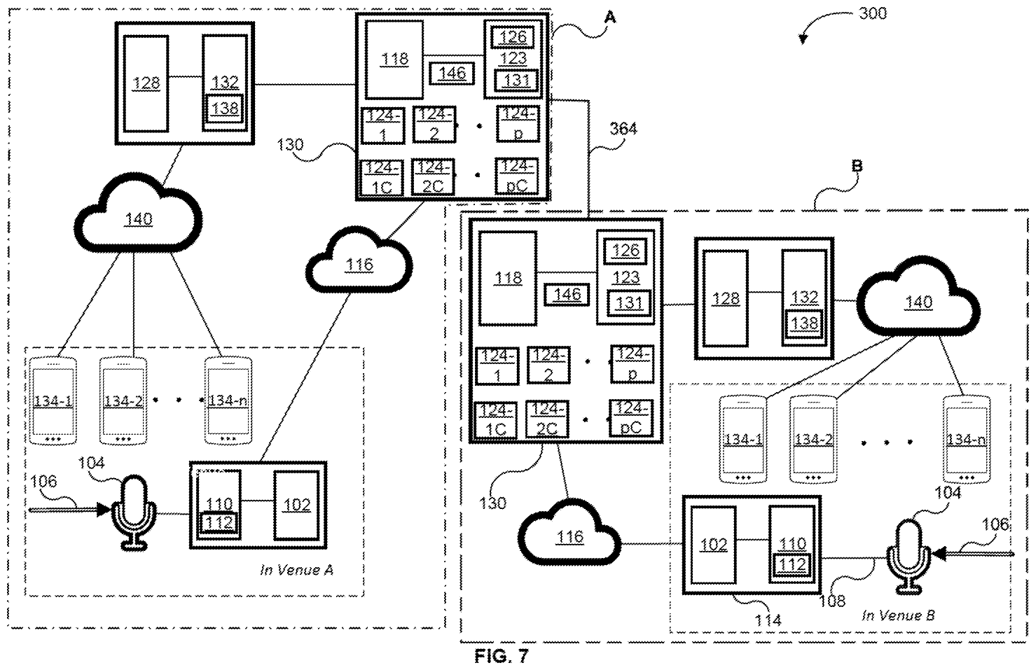

The described systems and methods may be scalable and reconfigurable for delivery of live streams between venues. For example, FIG. 7 depicts example system 300 for capturing and distributing a live audio or multi-media stream of a live event in real-time to a plurality of mobile computing devices. System 300 shows two subsystems, subsystem A and subsystem B associated with venue A and venue B, respectively. According to some embodiments, venue A and venue B are in different geographic locations (e.g., different cities, different municipal or state addresses). According to some embodiments, venue A and venue B are located in the same geographic region. According to some embodiments, venue A and venue B are not in the same geographic location, but the methods and systems described herein are configured to share live audio and multi-media streams and serve audio/video/multimedia from both venues (or a plurality of venues that may include venues A and B) to all connected mobile computing devices. For example, venues A and B may be located within the same geographic region but are part of a system which services mobile computing devices and shares live streams between venues located in multiple geographic regions.

Subsystems A and B are each configured similarly to example system 100. According to some embodiments, mobile computing devices 134 of venue A are subscribed to the live stream 106 of that venue but also subscribed to the live stream 106 of venue B. According to some embodiments, the second processing devices 118 of subsystems A and B are configured to communicate with each other, including in the transmission of transmission copies 124C generated by each second processing device between them such that mobile computing devices of one venue can receive live audio or multi-media streams from the other venue. For example, second processing device 118 of subsystem A is enabled to communicate with second processing device 118 of subsystem B via communication link 364. Communication link 364 comprises any suitable wired and/or wireless communication link(s), or suitable combination thereof. According to some embodiments, communication link 364 comprises one or more of a dedicated cellular uplink, a dedicated network uplink, a dedicated fiber link and the Internet. According to some embodiments, second processing device 118 of subsystem A is in communication with first processing device 102 and third processing device 128 of subsystem B (i.e., second processing device 118 of subsystem A is enabled to receive and transmit data from first processing device 102 and third processing device 128 of subsystem B).

Although two second processing devices 118A, 118B are depicted, it is understood that according to some embodiments, the operations/functionality of second processing devices 118A and 118B are embodied in a single second processing device and/or software/hardware module(s). For example, according to some embodiments, system 300 comprises an intermediary computing device and/or software/hardware module(s) that is configured to communicate directly with third processing devices 128A and 128B and provide the functionality of computing devices 130A, 130B (including that of second processing devices 118A, 118B). First processing devices 102A, 102B and third processing devices 128A, 128B are in communication with the intermediary computing device and/or software/hardware module(s) and the generation/distribution of transmission copies of the live stream from Venue A to mobile devices in Venue B, and vice versa, take place via the intermediary computing device and/or software/hardware module(s).

As discussed above, the described systems and methods take advantage of certain network infrastructure to help minimize latency while providing delivery of the captured live audio or multi-media stream to mobile devices in the same venue as the mobile device(s) or, as alluded to above, from another venue. Since many of the mobile devices in the venue, such as mobile devices 134, may be subscribers to second network 140, the described systems and methods utilize that existing network infrastructure to deliver the live audio or multi-media stream, such as live stream 106. However, usually second network 140 is not necessarily dedicated or constructed specifically to provide live audio or multi-media streams from the venue to mobile devices situated in that venue. As a result, simply transmitting the captured live audio or multi-media stream from the point of ingest (e.g., first processing device 102) via second network 140 without any consideration for the geographic location of the transceiver, other specific network infrastructure or mindful of other traffic that may be routed through second network 140 may result in an unacceptable amount of latency.

According to some embodiments, the described systems and methods utilize edge computing, such as multi-access edge computing, to reduce latency of the delivered live audio or multi-media stream while utilizing certain network infrastructure. For example, according to some embodiments, second processing device 118 is part of a multi-access edge computing platform associated with second network 140. As shown and described herein, the in-venue point of ingest of the live audio or multi-media stream (e.g., at first processor 102) is decoupled from much of the processing of the received live audio or multi-media stream (e.g., at second processing device 118). According to some embodiments, the processing of the received live audio or multi-media stream is performed at a network location proximate to the network through which the live audio or multi-media stream is being provided to the mobile devices. It is understood that moving such processing closer to the network delivering the live audio or multi-media stream may be helpful in reducing latency. For example, according to some embodiments, second processing device 118 is part of a multi-access edge computing platform associated with the second network 140, such as an edge node of second network 140. According to some embodiments, second processing device 118 is part of a virtual machine at the edge of second network 140.

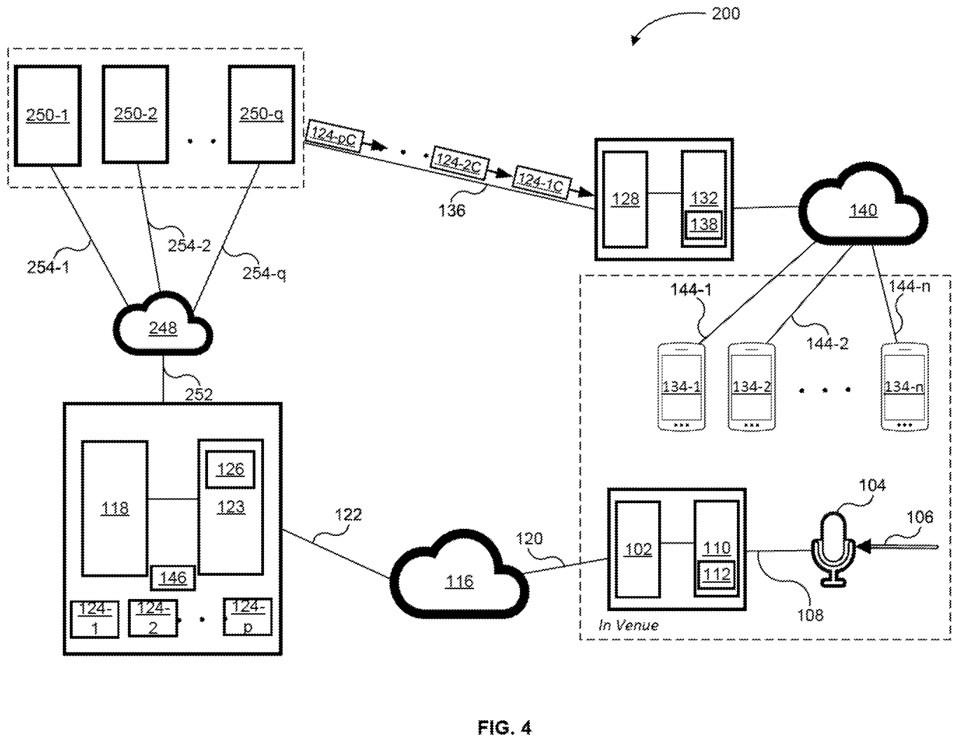

Attention is directed to FIG. 4, which depicts example system 200 for capturing and distributing a live audio or multi-media stream of a live event and in which like or similar elements are denoted by like or similar numbers shown in FIG. 3. For simplicity and ease of understanding, discussion of the elements depicted in FIG. 4 will focus on certain similarities and differences from those depicted in FIG. 3.

Similar to system 100 of FIG. 3, second processing device 118 receives live stream 106, or data representative thereof, from first processing device 102 via first network 116. Second processing device 118 then generates data packets 124. However, instead of being generated by second processing device 118, transmission copies 124C are generated by a plurality of ancillary processing devices and/or software/hardware modules, such as ancillary devices 250-1, 250-2 to 250-q (collectively, ancillary devices 250) that are in network communication with second processing device 118 via ancillary network 248. For example, second processing device 118 may be enabled to transmit data over ancillary network 248 via communication links 252 and 254-1, 254-2 to 254-q (communication links 254-1, 254-2 to 254-q referred to collectively as communication links 254). Communication links 252 and 254 comprise any suitable wired and/or wireless communication link(s), or suitable combination thereof. Second processing device 118 may also be configured to transmit and receive data over ancillary network 248 according to any suitable protocol or protocols, such as wired or wireless data protocols, cellular device protocols, WiFi protocols, WiMax protocols, Real-Time Transport Protocol (RTP) and/or a combination of protocols. According to some embodiments, the internal distribution of transmission copies 124C among ancillary devices 250 is performed in accordance with broadcast, multicast or unicast transmission protocols.

Second processing device 118 transmits the generated data packets 124 over ancillary network 248 for receipt by ancillary devices 250. Ancillary devices 250 generate transmission copies 124C, which are then transmitted from ancillary devices 250 one-at-a-time to third processing device 128. By leveraging the processing power of the ancillary processing devices 250, the overall processing load on second processing device 118 can be reduced. According to some embodiments, the number of ancillary devices 250 can be dynamically adjusted in response to demand for the live audio or multi-media stream from mobile devices 134.

As discussed above in respect of FIGS. 1 and 2, the typical server creates an output data queue for each attached client device. This output queue usually contains several data packets, which require a significant amount of memory to implement, require CPU time to manage, limit the number of concurrent client devices that can be supported by a single server and add latency to the audio stream.

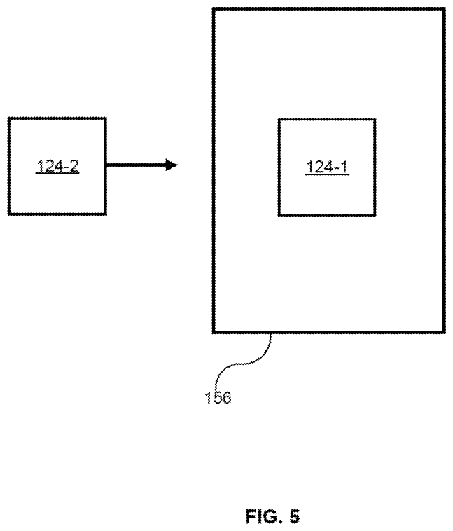

With that in mind, the described systems and methods employ additional mechanisms and processes to help improve latency. According to some embodiments, prior to transmitting the transmission copy of a respective discrete audio data packet, such as transmission copy 124-1C, second processing device 118 is further enabled to place the respective discrete audio data packet in a buffer 156 (see FIG. 5). According to some embodiments, the buffer 156 is configured to store a single one of data packets 124. The second processing device 118 generates copies of the respective data packet placed in the buffer 156 for transmission to third processing device 128. According to some embodiments, in transmitting a respective one of data packets 124 to third processing device 128, second processing device 118 retrieves the generated copies of the respective one of the data packets, such as transmission copy 124-1C, from buffer 156 for transmission to third processing device 128. According to some embodiments, second processing device 118 is further enabled to retrieve and transmit the transmission copy of each discrete audio data packet from the buffer before that transmission copy is overwritten by a transmission copy of a next discrete audio data packet generated from the live audio or multi-media stream is placed in the buffer.

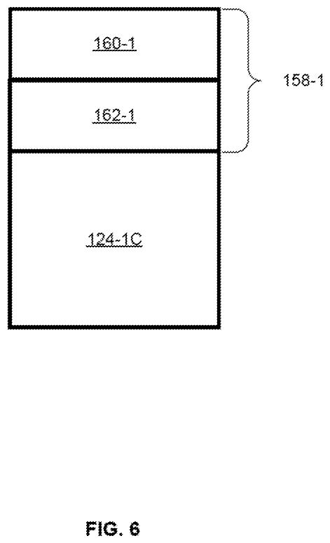

Attention is directed to FIG. 6, which shows transmission copy 124-1C, according to some embodiments. As discussed above, a list 131 of subscribing mobile computing devices may be maintained by system 100. According to some embodiments, the list 131 also includes a unique Internet Protocol (IP) address, various statistics and control information for each of the subscribing mobile computing devices, such as mobile computing devices 134. Some non-limiting examples of the control information include a timestamp, a packet sequence number (which may be used by a mobile computing device client to detect packet loss or restore the packet sequence), a payload type (such as G.711/Opus) and a source identifier.

According to some embodiments, for each copy of the discrete audio data packet, second processing device 118 generates a header comprising a packet sequence number associated with that copy of the discrete audio data packet and a unique identifier associated with the respective one of the mobile computing devices to which that copy of the discrete audio data packet is ultimately to be transmitted for receipt by second processing device 118. According to some embodiments, the packet sequence identifier number is included as part of control information about the respective mobile computing device. Prior to transmission of the copy of the discrete audio data packet to the third processing device, the header is added to that copy. In transmitting the transmission copy to third processing device 128, second processing device 118 transmits both the transmission copy with the header to third processing device 128.

For example, if copy 124-1C is to be transmitted ultimately for receipt by mobile computing device 134-1, second processing device 118 generates header 158-1 for copy 124-1C. The header 158-1 includes control information 160-1 and a unique identifier 162-1, such as a unique IP address, specifically associated with mobile computing device 134-1. The control information 160-1 may include a packet sequence identifier number identifying a position in the received live audio stream 106 associated with data packet 124-1. The control information 160-1 may also include other information about data packet 124-1, such as a data type.

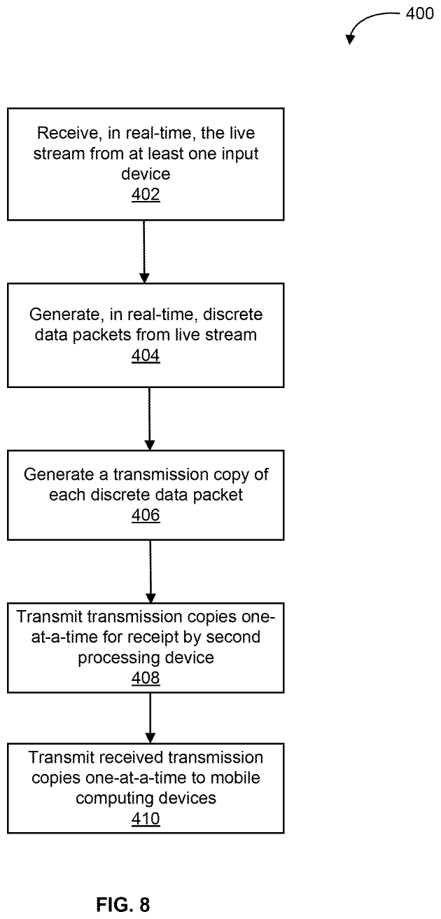

Attention is directed to FIG. 8, which depicts example method 400 for capturing and distributing a live audio or multi-media stream of a live event in real-time to a plurality of mobile computing devices. In order to assist in the explanation of method 400, it will be assumed that method 400 is performed using example systems 100, 200 and/or 300, as indicated. Furthermore, the following discussion of method 400 will lead to a further understanding of example systems 100, 200 and/or 300 and the various components of those systems. However, it is understood that example systems 100, 200, 300 and/or method 400 can be varied, and need not work exactly as discussed herein in conjunction with each other, and that such variations are within the scope of the present application.

It is appreciated that, in some embodiments, method 400 is implemented by processing devices 102, 118, 128. Indeed, method 400 is one way in which example systems 100, 200 and/or 300, and components thereof, may be configured. It is to be emphasized, however, that method 400 need not be performed in the exact sequence as shown, unless otherwise indicated; and likewise various block may be performed in parallel rather than in sequence. Hence, the elements of method 400 are referred to herein as “blocks” rather than “steps”. It is also understood, however, the method 400 can be implemented on variations of systems 100, 200 and/or 300.

At block 402, the live audio or multi-media stream from at least one audio or multi-media input device is received in real-time. For example, according to some embodiments, live stream 106 is received by second processing device 118, which is in remote communication with audio input device 104. For example, as shown in FIG. 3, communication between audio input device 104 and second processing device 118 takes place via first network 116.

At block 404, a plurality of discrete audio or multi-media data packets are generated, in real-time, from the live audio or multi-media stream. For example, according to some embodiments, data packets 124 are generated by second processing device 118.

At block 406, a transmission copy of each one of the discrete audio or multi-media data packets is generated. For example, according to some embodiments, transmission copies 124C are generated by second processing device 118.

At block 408, the transmission copies are transmitted one-at-a-time for receipt by another processing device. For example, according to some embodiments, transmission copies 124C are transmitted one-at-a-time by second processing device 118 for receipt by third processing device 128.

At block 410, at the other processing device, each received transmission copy is transmitted over a network for receipt by the plurality of mobile computing devices prior to transmitting another received transmission copy for receipt by the plurality of mobile computing devices. For example, according to some embodiments, as each one of transmission copies 124C is received by third processing device 128, third processing device 128 transmits that received transmission copy over second network 140 for receipt by mobile computing devices 134 prior to transmitting another one of the received transmission copies (for example, transmission copy 124-1C would be transmitted prior to transmitting 124-2C).

As discussed above, according to some embodiments, the transmission of the transmission copies by the second processing device to the mobile computing device(s) is preceded by a generic UDP data packet to establish a connection or communication between the second processing device (or the associated media manager) and the mobile computing device(s). In some cases, the second processing device and the mobile computing devices are on different or otherwise segregated networks with one or more network routing devices in between. For example, according to some embodiments, the second processing device may be associated with a public network and one or more of the mobile computing devices may be associated with a private network, such as a cellular network. In such cases, as noted by the Applicant, the network routing devices tend to perform Network Address Translation (NAT) when passing UDP traffic between the two networks. For example, the network may: change the source Internet Protocol (IP) address of the data packets transmitted from the mobile computing devices to the second processing device; change the source port identifier (such as a source port number) of the data packets transmitted by from the mobile computing devices to the second processing device, noting that the new source port identifier may be randomly assigned; and, block UDP data packets transmitted from the second processing device to the mobile computing devices unless a communication pathway has been previously opened through the network routing device(s) by the mobile computing devices associated with the first network. In such cases, a communication path between the second processing device and the mobile computing devices is typically established before transmission of the transmission copies.

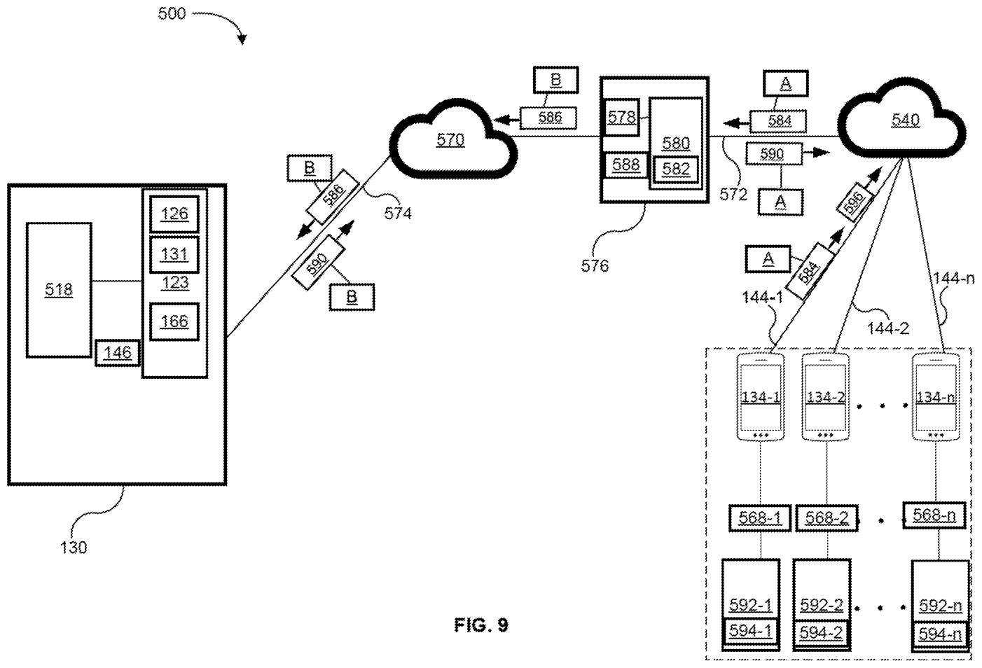

Attention is directed to FIG. 9, which depicts example system 500 for establishing UDP communication between computing devices and in which like or similar elements are denoted by like or similar numbers shown in FIGS. 3 to 7. For simplicity and ease of understanding, discussion of the elements depicted in FIG. 9 will focus on certain similarities and differences from those depicted in FIGS. 3 to 7.

System 500 comprises at least one client processing device, such as client processing devices 568 (individually, client processing device 568-1, 568-2. 568-n) of mobile computing devices 134. Mobile computing devices 134, and thereby also client processing devices 568, are associated with network 540. According to some embodiments, network 540 is a private network, such as a LAN of the venue, a cellular carrier network or subsystem network, such as a RAN of a cellular carrier or other mobile network operator. According to some embodiments, network 540 comprises a cloud RAN (C-RAN). As such, mobile computing devices 134 may be mobile devices registered or otherwise granted access to the cellular carrier network. Any suitable cellular network is contemplated by this application. For example, according to some embodiments, second network 540 is an LTE, 5G or 6G network.

System 500 further comprises processing device 518. Processing device 518 is similarly configured to processing device 118 described above. Processing device 518 is associated with network 570. Network 570 is different than network 540. According to some embodiments, network 570 is a public network, such as the Internet. According to some embodiments, network 570 is another LAN that is distinct from network 540. At least one of processing devices 568 is connected to processing device 518 via communication links 572 and 574. Communication links 572 and 574 comprise any suitable wired and/or wireless communication link(s), or suitable combination thereof. Processing devices 568 and 518 are configured to transmit and receive data over communication links 572 and 574 according to any suitable protocol, such as wired or wireless data protocols, cellular device protocols, WiFi protocols, WiMax protocols, Real-Time Transport Protocol (RTP) and/or a combination of protocols. Transmission between processing devices 568 and 518 is typically in accordance with UDP.

System 500 further comprises a networking routing device, such as network routing device 576, intermediate networks 540 and 570. Data being transmitted from processing devices 568 to processing device 518, and vice versa, passes through networking routing device 576. Networking routing device 576 comprises one or more suitable routing devices, such as switches, hubs, routers, gateways, modules, repeaters, bridges, bridging routers and any other device or devices required for communication and interaction between devices on a computer network. Network routing device 576 comprises at least one network routing processing device, such as network routing processing device 578, which is coupled to memory device 580 configured to store network routing device computer-executable instructions 582. Memory device 580 can comprise any suitable memory device, including but not limited to any suitable one of, or combination of, a local and/or remote volatile memory, non-volatile memory, random access memory (RAM), read-only memory (ROM), hard drive, optical drive, buffer(s), cache(s), flash memory, magnetic computer storage devices (e.g. hard disks, floppy disks, and magnetic tape), optical memory ((e.g., CD(s) and DVD(s)), and the like. Other suitable memory devices are also within the scope of the application.

Network routing device computer-executable instructions 582 are configured such that when executed by network routing processing device 578 the network routing processing device 578 is caused to perform various tasks. As shown in FIG. 9, network routing processing device 578 is caused to receive, from at least one of client processing devices 568, a generic UDP data packet associated with a first source network identifier. For example, according to some embodiments, client processing device 568-1 generates generic UDP data packet 584 for transmission along communication links 144-1, 572 and 574. Generic UDP data packet 584 may be empty; however, it is contemplated that generic UDP data packet may comprise any data representative of being a generic data packet. According to some embodiments, the generic UDP data packet contains a header comprising a packet sequence number associated with it and/or a discrete identifier associated with a respective one of the plurality of client processing devices but does not comprise any audio data in its payload. According to some embodiments, the generic UDP data packet comprises audio data in its payload. The first source network identifier comprises any information or data identifying or otherwise indicative of the network from which the transmitted data packet originates. For example, when at least one of processing devices 568 generates generic UDP data packet 584, the first source network identifier is indicative of network 540 associated with client processing devices 568 (or, more generally, mobile computing devices 134). According to some embodiments, the selection of the first source network identifier is random. According to some embodiments, the first source network identifier, such as first source network identifier A, comprises at least one of a first source port identifier, such as a port number, and a first source IP address. According to some embodiments, the first source network identifier A comprises a first source port identifier. According to some embodiments, the first source network identifier A comprises a first source IP address, such as an IP address associated with network 540. According to some embodiments, the first source network identifier A comprises both a first source port identifier and a first source IP address.

After receiving the generic UDP data packet, the network routing processing device(s) is enabled to, in accordance with network routing device computer-executable instructions, to generate an updated generic UDP data packet by changing the first source network identifier to a second source network identifier. For example, according to some embodiments, network routing processing device(s) 576 is enabled to, in accordance with network routing device computer-executable instructions 582, to generate updated generic UDP data packet 586 with the first source network identifier A changed to a second source network identifier B. According to some embodiments, the selection of the second source network identifier is random. As with the first source network identifier, according to some embodiments, the second source network identifier comprises at least one of a second source port identifier and a second source IP address. According to some embodiments, the second source network identifier comprises a second source port identifier. According to some embodiments, the second source network identifier comprises a second source IP address. According to some embodiments, the second source network identifier A comprises both a second source port identifier and a second source IP address.

The network routing processing device(s) is enabled to, in accordance with network routing device computer-executable instructions, generate a map of the first source network identifier to the second source network identifier using Network Address Translation (NAT). For example, according to some embodiments, network routing processing device 578 is enabled to, in accordance with network routing device computer-executable instructions 582, generate map 588. Map 588 comprises data at least indicative of the relationship between first source network identifier A and second source network identifier B.

In accordance with network routing device computer-executable instructions, the network routing device(s) is enabled to transmit, for receipt by the processing device associated with the second network, the updated generic UDP data packet. For example, according to some embodiments, network routing processing device 578 is enabled to transmit updated generic UDP data packet 586 having second source network identifier B.

The network routing device(s) is further enabled to receive, from the processing device associated with the second network, at least one data packet transmitted in accordance with the second source network identifier. For example, according to some embodiments, network routing processing device 578 is enabled to receive, in accordance with network routing device computer-executable instructions 582, data packet 590 transmitted in accordance with second source network identifier B for receipt by processing device 518.

Further in accordance with network routing device computer-executable instructions, the network routing processing device(s) is enabled to translate the second source network identifier to the first source network identifier in accordance with the map. For example, according to some embodiments, network routing processing device 578 is enabled to translate second source network identifier B to first source network identifier A, resulting in data packet 590 now associated with the first source network identifier A.

After translating the source network identifiers, the network routing processing device(s) is enabled to transmit the received at least one data packet to the client processing device in accordance with the first source network identifier. For example, according to some embodiments, networking routing processing device 578 is enabled to transmit data packet 590 associated with first source network identifier A for receipt by client processing device 568-1.

According to some embodiments, processing device 518 is enabled to, in accordance with processing device computer-executable instructions, receive the updated generic UDP data packet, read the second source network identifier and generate at least one data packet associated with the second source network identifier. For example, according to some embodiments, processing device 518 is enabled to read second source identifier B from updated generic UDP data packet 586 and then generate at least one data packet associated with second source network identifier B, such as data packet 590 which may be responsive to a request from client processing devices 568 (which can be understood as requests from mobile computing devices 134).

According to some embodiments, processing device 518 does not have administrative control over network routing device 576 (or network routing processing device 578). According to some embodiments, the mapping performed in accordance with NAT at the network routing device(s) is random and not static. If processing device 518 does not have administrative control over network routing device 576 (or network routing processing device 578), the mapping of the first source network identifier to the second source network identifier is not predetermined or easily predicted. Transmitting the generic UDP data packet in accordance with the methods and systems described herein typically creates a pathway for UDP communication between devices on different networks (such as client processing devices 568 and processing device 518). In other words, performing or implementing the methods and systems described herein typically: (i) opens a UDP port at the network routing device(s) to allow for UDP traffic to be transmitted from the processing device 518 to mobile device(s) 134 (or client processing devices 568) and (ii) initiates the mapping at the network routing device(s) (or network routing processing device 578) for UDP communication between processing device 518 and mobile device(s) 134 (or client processing device(s) 568).

According to some embodiments, at least one of client processing devices 568 is enabled to initiate a streaming session with computing device 130 (or processing device 518). For example, according to some embodiments, at least one of client processing devices 568 is enabled to transmit a Transmission Control Protocol (TCP) request for data for receipt by processing device 518 via network routing device 576 (or network routing processing device 578) prior to transmission of generic UDP data packet 584. For example, each of client processing devices 568 may be coupled to a respective one of client memory devices 592 (individually, client memory devices 592-1, 592-2 . . . 592-n) configured to store client computer-executable instructions 594 (individually, client computer-executable instructions 594-1, 594-2. 594-n) that when executed causes the respective one of client processing devices 592 to transmit TCP request 596 prior to transmitting generic UDP data packet 584. According to some embodiments, TCP request 596 is generated by the respective one of client processing devices 568. For example, according to some embodiments, TCP request 596 is a request for processing device 518 to transmit data in accordance with UDP to a specific one of mobile computing devices 134. Since the route has not yet been configured through the network routing device(s), the network routing device would likely block such transmission from processing device 518 (as unsolicited traffic from a second source network different than the first source network) or transmit the requested data to the wrong one of mobile computing devices 134 or other device (such as a device on the first source network with a similar source network identifier). In either situation, the requesting mobile computing device would not receive the requested data.

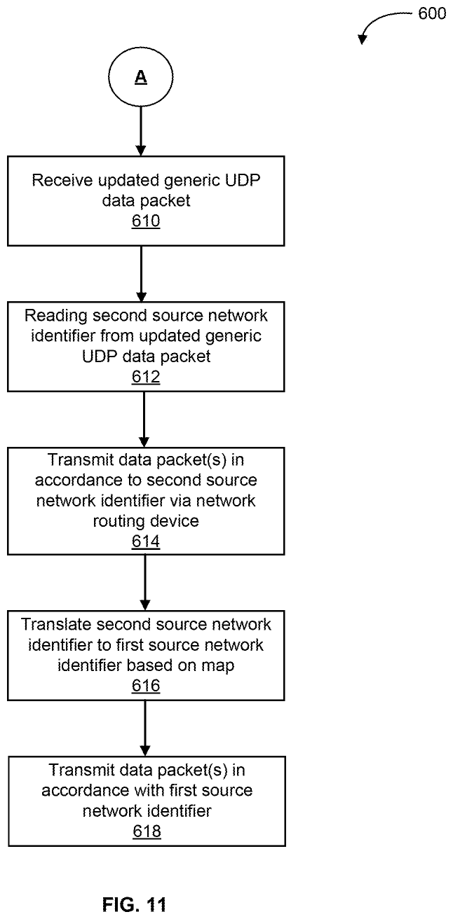

Attention is directed to FIGS. 10 and 11, which depict example method 600 for establishing UDP communication between a client processing device associated with a first network and a processing device associated with a second network. In order to assist in the explanation of method 600, it will be assumed that method 600 is performed using example system 500, as indicated. Furthermore, the following discussion of method 600 will lead to a further understanding of example system 500 and the various components of that system. However, it is understood that example system 500 and/or method 600 can be varied, and need not work exactly as discussed herein in conjunction with each other, and that such variations are within the scope of the present application.

It is appreciated that, in some embodiments, method 600 is implemented by processing devices 568, 578 and/or 518. Indeed, method 600 is one way in which example system 500, and components thereof, may be configured. It is to be emphasized, however, that method 600 need not be performed in the exact sequence as shown, unless otherwise indicated; and likewise various block may be performed in parallel rather than in sequence. Hence, the elements of method 600 are referred to herein as “blocks” rather than “steps”. It is also understood, however, the method 600 can be implemented on variations of system 500.

At block 602, a generic UDP data packet, such as generic UDP data packet 584, is transmitted from at least one of client processing devices 568 via network routing device 576 (or, more specifically, network routing processing device 578). As noted above, the generic UDP data packet is associated with a first source network identifier, such as first source network identifier A indicative of network 540.

Upon receipt of generic UDP data packet 584 by the network routing device 576 (or, more specifically, networking routing processing device 578), at blocks 604 to 608, an updated generic UDP data packet is generated by changing the first source network identifier to a second source network identifier, a map of the first source network identifier to the second network identifier is generated using NAT, and the updated generic UDP data packet is transmitted for receipt by the processing device. For example, according to some embodiments, upon receipt of generic UDP data packet 584 by network routing device 576, updated generic UDP data packet 586 associated with second source network identifier B is generated, map 588 of first source network identifier A to second source network identifier B is generated using NAT, and updated generic UDP data packet 586 associated with second source network identifier B is transmitted by network routing device 576 (or by network routing processing device 578) for receipt by processing device 518.

At blocks 610 to 614, processing device 518 receives updated generic UDP data packet 586, reads second source network identifier B, and transmits at least one data packet via network routing device 576 (or network routing processing device 578) to at least one of client processing devices 568 in accordance with second source network identifier B, such as data packet 590. For example, according to some embodiments, the at least one data packet being transmitted in accordance with second source network identifier B is in response to a request for data from at least one of client processing devices 568.

At block 616, upon receipt of the at least one data packet 590, network routing device 576 (or network routing processing device 578) translates second source network identifier B to first source network identifier A in accordance with map 588. At block 618, network routing device 576 (or network routing processing device 578) transmits said data packets in accordance with first source network identifier A.

As discussed above, according to some embodiments, at least one of the client processing devices transmits a request for data to processing device 518. For example, at block 620, at least one of client processing devices 568 transmits a TCP request for data from processing device 518, such as TCP request 596, via network routing device 576 (or network routing processing device 578).

According to some embodiments, prior to transmitting the generic UDP data packet, a source port at the network routing device 578 (or network routing processing device 578) is opened for UDP data traffic. For example, according to some embodiments, at least one of mobile computing devices 134 (or the respective one of client processing devices 568) transmits TCP request 596 for receipt by processing device 518, the requesting mobile computing device transmits the generic UDP data packet in accordance with the methods and systems described herein, and, in performing the NAT translation, the network routing device(s) establishes a port for UDP traffic between the requesting mobile computing device and processing device 518. In other words, transmitting the generic UDP data packet in accordance with the methods and systems described herein effectively opens a UDP pathway, allowing UDP traffic from processing device 518 to the requesting mobile computing device, and provides processing device 518 in accordance with the second source network identifier indicative of the port and/or IP address to which it can direct the requested data. Processing device 518 then sends audio via this pathway, which is then forwarded on to the requesting mobile computing device by network routing device(s) 576 (or network routing processing device(s) 578) in accordance with map 588.

According to some embodiments, at least some blocks of method 400 are periodically performed to keep a port of the networking routing device open and the map accurate. For example, according to some embodiments, at least one of client processing devices 568 periodically transmits a generic UDP data packet and the map is updated accordingly.

According to some embodiments, at least some aspects of system 500 and method 600 are integrated into the systems 100, 200 and/or 300 and/or method 400. For example, according to some embodiments, the transmission of data packet 590 associated with second source network identifier B is commensurate with the transmission of the transmission copies 124C. According to such embodiments, the transmission copies 124C are transmitted to mobile computing devices 134 via network routing device 576 (or network routing processing device 578), which translates the second source network identifier B to first source network identifier A.

As discussed above, the systems and methods described herein can minimize end-to-end latency between the audio source and the mobile computing device clients. According to some embodiments, system latency time, the time from which live stream 106 is received at input device 104 to the time each one of the transmission copies generated from live stream 106 are transmitted to mobile computing devices 134, is less than 500 mS. According to some embodiments, the system latency time is in the range of about 100 mS to about 500 mS. According to some embodiments, the system latency time is in the range of near-zero mS to about 100 mS. According to some embodiments, the system latency time is in the range of near-zero mS to about 25 mS. For example, according to some embodiments, the system latency time is in the range of about 0.1 mS to about 100 mS or about 0.1 mS to about 25 mS or about 0.1 mS to about 500 mS.

A collection of exemplary examples, including at least some explicitly enumerated as “ECs” (Example Combinations), providing additional description of a variety of example types in accordance with the concepts described herein are provided below. These examples are not meant to be mutually exclusive, exhaustive, or restrictive; and the invention is not limited to these example examples but rather encompasses all possible modifications and variations within the scope of the issued claims and their equivalents.

EC 1. A system for capturing and distributing a live audio or multi-media stream of a live event in real-time to a plurality of mobile computing devices, the system comprising: a first memory device configured to store first computer-executable instructions, a first processing device coupled to the first memory device and at least one audio or multi-media input device configured to receive the live audio or multi-media stream; a second memory device configured to store second computer-executable instructions and a second processing device coupled to the second memory device, the second processing device being in remote communication with the first processing device; a third memory device configured to store third computer-executable instructions and a third processing device coupled to the third memory device, the third processing device being remote from the first processing device; the first computer-executable instructions when executed by the first processing device causes the first processing device to: receive the live audio or multi-media stream via the at least one audio or multi-media input device, and transmit, over a first network, the received live audio or multi-media stream for receipt by the second processing device; the second-computer executable instructions when executed by the second processing device causes the second processing device to: upon receipt of the live audio or multi-media stream from the first processing device, generate, in-real time, a plurality of discrete audio or multi-media data packets from the live audio or multi-media stream, generate a transmission copy of each one of the plurality of discrete audio or multi-media data packets, and transmit the transmission copies one-at-a time for receipt by the third processing device; wherein the third-computer executable instructions when executed by the third processing device causes the third processing device to: as each transmission copy is received, transmit that received transmission copy over a second network for receipt by the plurality of mobile computing devices prior to transmitting another received transmission copy for receipt by the plurality of mobile computing devices.

EC 2. The system of any of the preceding or subsequent example combinations, wherein the second network is a cellular carrier network.

EC 3. The system of any of the preceding or subsequent example combinations, wherein the second network is an LTE, a 4G, a 5G or a 6G network.

EC 4. The system of any of the preceding or subsequent example combinations, wherein the second processing device is part of a multi-access edge computing platform associated with the second network.

EC 5. The system of any of the preceding or subsequent example combinations, wherein the second processing device is an edge node of the second network.

EC 6. The system of any of the preceding or subsequent example combinations, wherein the first computer-executable instructions when executed by the first processing device further causes the first processing device to: encode the received live audio or multi-media stream in accordance with User Datagram Protocol (UDP) prior to transmission to the second processing device.

EC 7. The system of any of the preceding or subsequent example combinations, wherein the second processing device is in network communication with a plurality of ancillary processing devices via an ancillary network and transmission of the transmission copies comprises: via the ancillary network, internally distributing each transmission copy among the plurality of ancillary devices by the second processing device; and transmitting, from the ancillary devices, the transmission copies one-at-a-time for receipt by the third processing device.

EC 8. The system of any of the preceding or subsequent example combinations, wherein the internal distribution is performed in accordance with broadcast, multicast or unicast transmission protocols.

EC 9. The system of any of the preceding or subsequent example combinations, wherein the second computer-executable instructions when executed by the second processing device further causes the second processing device to, prior to transmitting the transmission copies to the third processing device: place each discrete audio data packet of the plurality of discrete audio data packets in a buffer and generate the transmission copy of each, wherein the transmission copies are generated from the discrete audio data packets placed in the buffer; and as each discrete audio data packet is generated, retrieve the respective transmission copy from the buffer for transmission to the third processing device.

EC 10. The system of any of the preceding or subsequent example combinations, wherein the second processing device is enabled to retrieve and transmit the transmission copy of each discrete audio data packet from the buffer before that transmission copy is overwritten by a transmission copy of a next discrete audio data packet generated from the live audio or multi-media stream is placed in the buffer.

EC 11. The system of any of the preceding or subsequent example combinations, wherein the buffer is configured to store a single one of the discrete audio data packets.

EC 12. The system of any of the preceding or subsequent example combinations, wherein the second computer-executable instructions when executed by the second processing device further cause the second processing device to, for each discrete audio data packet: generate a header comprising a packet sequence number associated with the transmission copy of that discrete audio data packet and a unique identifier associated with a respective one of the plurality of mobile computing devices; and add the header with the transmission copy of that discrete audio data packet, prior to transmitting that transmission copy to the third processing device.

EC 13. The system of any of the preceding or subsequent example combinations, wherein the plurality of mobile devices have subscribed to the live audio or multi-media stream.

EC 14. The system of any of the preceding or subsequent example combinations, wherein the time from receiving the live audio or multi-media stream via the at least one audio or multi-media input device to the transmission of each one of the transmission copies to the plurality of mobile computing devices is in the range of: about near-zero milliseconds (mS) to about 25 mS, or about near-zero mS to about 100 mS, or about 100 mS to about 500 mS, or about 500 mS or less

EC 15. A system for capturing and distributing a live audio or multi-media stream of a live event in real-time to a plurality of mobile computing devices, the system comprising: a first subsystem comprising the system of any one of the preceding example combinations; and a second subsystem comprising the system of any one of the preceding example combinations, wherein the second subsystem is in communication with the first subsystem.

EC 16. A system for distributing a live audio or multi-media stream of a live event in real-time to a plurality of mobile computing devices, the system comprising: a memory device configured to store computer-executable instructions and a processing device coupled to the memory device, the computer-executable instructions when executed by the processing device causes the processing device to: upon receipt, via a first network, of the live audio or multi-media stream from at least one audio device remote from the processing device, generate, in-real time, a plurality of discrete audio data packets from the live audio or multi-media stream, generate a transmission copy of each one of the plurality of discrete audio data packets, and transmit the transmission copies one-at-a time to a provider processing device; wherein the provider processing device is configured to, in accordance with a transmission policy associated with the provider processing device: as each transmission copy is received, transmit that received transmission copy over a provider network for receipt by the plurality of mobile computing devices prior to transmitting another received transmission copy.

EC 17. The system of any of the preceding or subsequent example combinations, wherein the provider network is a cellular carrier network.

EC 18. The system of any of the preceding or subsequent example combinations, wherein the provider network is an LTE, a 4G, a 5G or a 6G network.

EC 19. The system of any of the preceding or subsequent example combinations, wherein the processing device is part of a multi-access edge computing platform associated with the provider network.

EC 20. The system of any of the preceding or subsequent example combinations, wherein the processing device is an edge node of the provider network.

EC 21. A method for capturing and distributing a live audio or multi-media stream of a live event in real-time to a plurality of mobile computing devices, the method comprising: at a first processing device: receiving, in real-time, the live audio or multi-media stream from at least one audio or multi-media input device, the first processing device being in remote communication with the at least one audio or multi-media input device; generating, in real-time, a plurality of discrete audio or multi-media data packets from the live audio or multi-media stream; generating a transmission copy of each one of the plurality of discrete audio or multi-media data packets, and transmitting the transmission copies one-at-a-time for receipt by a second processing device; and at the second processing device: as each transmission copy is received, transmitting that received transmission copy over a network for receipt by the plurality of mobile computing devices prior to transmitting another received transmission copy for receipt by the plurality of mobile computing devices.

EC 22. The method of any of the preceding or subsequent example combinations, wherein the network is a cellular carrier network.

EC 23. The method of any of the preceding or subsequent example combinations, wherein the network is an LTE, a 4G, a 5G or a 6G network.

EC 24. The method of any of the preceding or subsequent example combinations, wherein the first processing device is part of a multi-access edge computing platform associated with the network.

EC 25. The method of any of the preceding or subsequent example combinations, wherein the first processing device is an edge node of the network.

EC 26. A non-transitory computer-readable medium for capturing and distributing a live audio or multi-media stream of a live event in real-time to a plurality of mobile computing devices, the computer-readable medium comprising computer-executable instructions for: at a first processing device: receiving, in real-time, the live audio or multi-media stream from at least one audio or multi-media input device, the first processing device being in remote communication with the at least one audio or multi-media input device; generating, in real-time, a plurality of discrete audio or multi-media data packets from the live audio or multi-media stream; generating a transmission copy of each one of the plurality of discrete audio or multi-media data packets, and transmit the transmission copies one-at-a-time for receipt by a second processing device; and at the second processing device: as each transmission copy is received, transmit that received transmission copy over a network for receipt by the plurality of mobile computing devices prior to transmitting another received transmission copy for receipt by the plurality of mobile computing devices.

EC 27. The non-transitory computer-readable medium of any of the preceding or subsequent example combinations, wherein the computer-readable medium further comprises computer-executable instructions for: performing the method of any one of EC 21 to EC 25.

EC 28. A system for capturing and distributing a live audio or multi-media stream of a live event in real-time to a plurality of mobile computing devices, the system comprising: a processing device coupled to a memory device configured to store computer-executable instructions; and a streaming module in communication with the processing device, the streaming module configured to: receive the live audio or multi-media stream, or data indicative thereof, generate, in-real time, a plurality of discrete audio or multi-media data packets from the live audio or multi-media stream, generate a transmission copy of each one of the plurality of discrete audio or multi-media data packets, and transmit the transmission copies one-at-a time for receipt by the processing device; wherein the computer executable instructions when executed by the processing device cause the processing device to, as each transmission copy is received, transmit that received transmission copy over a network for receipt by the plurality of mobile computing devices prior to transmitting another received transmission copy for receipt by the plurality of mobile computing devices.

EC 29. The system of any of the preceding or subsequent example combinations, wherein the second network is a cellular carrier network.

EC 30. The system of any of the preceding or subsequent example combinations, wherein the second network is an LTE, a 4G, a 5G or a 6G network.

EC 31. The system of any of the preceding or subsequent example combinations, wherein the streaming module is part of a multi-access edge computing platform associated with the network.

EC 32. The system of any of the preceding or subsequent example combinations, wherein the streaming module is an edge node of the second network.

EC 33. The system of any of the preceding or subsequent example combinations, wherein the streaming module is further configured to encode the received live audio or multi-media stream in accordance with User Datagram Protocol (UDP) prior to transmission to the processing device.

EC 34. A method for establishing UDP communication between a client processing device associated with a first network and a processing device associated with a second network, the method comprising: transmitting from the client processing device a generic UDP data packet via a network routing device, wherein the generic UDP data packet is associated with a first source network identifier; upon receipt of the generic UDP data packet by the network routing device: generating an updated generic UDP data packet by changing the first source network identifier to a second source network identifier, generating a map of the first source network identifier to the second source network identifier using Network Address Translation (NAT), and transmitting, for receipt by the processing device, the updated generic UDP data packet; at the processing device, receiving the updated generic UDP data packet, and reading the second source network identifier; transmitting at least one data packet from the processing device to the client processing device via the network routing device in accordance with the second source network identifier, wherein upon receipt of the at least one data packet, the network routing device translates the second source network identifier to the first source network identifier in accordance with the map and transmits the at least one data packet in accordance with the first source network identifier.

EC 35. The method of any of the preceding or subsequent example combinations, wherein the first source network identifier comprises at least one of a first source port identifier and a first source IP address.

EC 36. The method of any of the preceding or subsequent example combinations, wherein the second source network identifier comprises at least one of a second source port identifier and a second source IP address.

EC 37. The method of any of the preceding or subsequent example combinations, further comprising: prior to transmitting the generic UDP data packet from the client processing device, transmitting a Transmission Control Protocol (TCP) request for data from the client processing device to the processing device via the network routing device.

EC 38. The method of any of the preceding or subsequent example combinations, further comprising: periodically performing the method of any one of EC 34 to EC 37.

EC 39. The method of any of the preceding or subsequent example combinations, further comprising: prior to transmitting the generic UDP data packet from the client processing device, opening a source port for UDP data traffic at the network routing device.

EC 40. The method of any of the preceding or subsequent example combinations, wherein the first network is a private network and the second network is a public network.

EC 41. The method of any of the preceding or subsequent example combinations, wherein the private network is a cellular carrier network.

EC 42. The method of any of the preceding or subsequent example combinations, wherein the cellular carrier network is an LTE, a 4G, 5G or 6G network.

EC 43. A system for establishing UDP communication between computing devices, the system comprising: a client processing device associated with a first network; a processing device associated with a second network; a network routing device comprising a network routing processing device coupled to a memory device configured to store network routing device computer-executable instructions, the network routing device computer-executable instructions when executed cause the network routing device processing device to: receive, from the client processing device, a generic UDP data packet associated with a first source network identifier; generate an updated generic UDP data packet by changing the first source network identifier to a second source network identifier; generate a map of the first source network identifier to the second source network identifier using NAT; transmit, for receipt by the processing device, the updated generic UDP data packet; receive, from the processing device, at least one data packet transmitted in accordance with the second source network identifier; translate the second source network identifier to the first source network identifier in accordance with the map; and transmit the received at least one data packet for receipt by the client processing device in accordance with the first source network identifier.

EC 44. The system of any of the preceding or subsequent example combinations, wherein the first source network identifier comprises at least one of a first source port identifier and a first source IP address.

EC 45. The system of any of the preceding or subsequent example combinations, wherein the second source network identifier comprises at least one of a second source port identifier and a second source IP address.

EC 46. The system of any of the preceding or subsequent example combinations, wherein the processing device is coupled to a processing memory device configured to store processing device computer-executable instructions that when executed causes the processing device to, prior to the receipt of the at least one data packet transmitted in accordance with the second source network identifier: receive the updated generic UDP data packet; read the second source network identifier from the updated generic UDP data packet; and generate the at least one data packet associated with the second source network identifier.

EC 47. The system of any of the preceding or subsequent example combinations, wherein the client processing device is coupled to a client memory device configured to store client device computer-executable instructions that when executed causes the client processing device to: transmit a TCP request for data to the processing device via the network routing processing device prior to the transmission of the generic UDP data packet.

EC 48. The system of any of the preceding or subsequent example combinations, wherein the first network is a private network and the second network is a public network.

EC 49. The system of any of the preceding or subsequent example combinations, wherein the first network is a cellular carrier network.

EC 50. The system of any of the preceding or subsequent example combinations, wherein the cellular carrier network is an LTE, a 4G, 5G or 6G network.

EC 51. The system of any of the preceding or subsequent example combinations, wherein the processing device does not have administrative control over the network routing device.

EC 52. A non-transitory computer-readable medium for establishing UDP communication between a client processing device associated with a first network and a processing device associated with a second network, the computer-readable medium comprising computer executable instructions for: transmitting from the client processing device a generic UDP data packet via a network routing device, wherein the generic UDP data packet is associated with a first source network identifier; upon receipt of the generic UDP data packet by the network routing device: generating an updated generic UDP data packet by changing the first source network identifier to a second source network identifier, generating a map of the first source network identifier to the second source network identifier using Network Address Translation (NAT), and transmitting, for receipt by the processing device, the updated generic UDP data packet; at the processing device, receiving the updated generic UDP data packet, and reading the second source network identifier; and, transmitting at least one data packet from the processing device to the client processing device via the network routing device in accordance with the second source network identifier, wherein upon receipt of the at least one data packet, the network routing device translates the second source network identifier to the first source network identifier in accordance with the map and transmits the at least one data packet in accordance with the first source network identifier.

EC 53. The non-transitory computer-readable medium of any of the preceding or subsequent example combinations, wherein the computer-readable medium further comprises computer-executable instructions for: performing the method of any one of EC 34 to EC 42.

Persons skilled in the art will appreciate that there are yet more alternative implementations and modifications possible, and that the above examples are only illustrations of one or more implementations. The scope, therefore, is only to be limited by the claims appended hereto.

### INTERPRETATION

It will also be understood that for the purposes of this application, “at least one of X, Y, and Z” or “one or more of X, Y, and Z” language can be construed as X only, Y only, Z only, or any combination of two or more items X, Y, and Z (e.g., XYZ, XYY, YZ, ZZ).

In the present application, components may be described as being “configured to” or “enabled to” perform one or more functions. Generally, it is understood that a component that is configured to or enabled to perform a function is configured to or enabled to perform the function, or is suitable for performing the function, or is adapted to perform the function, or is operable to perform the function, or is otherwise capable of performing the function.

Additionally, components in the present application may be described as being “operatively connected to”, “operatively coupled to”, and the like, to other components. It is understood that such components are connected or coupled to each other in a manner to perform a certain function. It is also understood that “connections”, “coupling” and the like, as recited in the present application include direct and indirect connections between components.

References in the application to “one embodiment”, “an embodiment”, “an implementation”, “a variant”, etc., indicate that the embodiment, implementation or variant described may include a particular aspect, feature, structure, or characteristic, but not every embodiment, implementation or variant necessarily includes that aspect, feature, structure, or characteristic. Moreover, such phrases may, but do not necessarily, refer to the same embodiment referred to in other portions of the specification. Further, when a particular aspect, feature, structure, or characteristic is described in connection with an embodiment, it is within the knowledge of one skilled in the art to affect or connect such module, aspect, feature, structure, or characteristic with other embodiments, whether or not explicitly described. In other words, any module, element or feature may be combined with any other element or feature in different embodiments, unless there is an obvious or inherent incompatibility, or it is specifically excluded.

It is further noted that the claims may be drafted to exclude any optional element. As such, this statement is intended to serve as antecedent basis for the use of exclusive terminology, such as “solely”, “only”, and the like, in connection with the recitation of claim elements or use of a “negative” limitation. The terms “preferably”, “preferred”, “prefer”, “optionally”, “may”, and similar terms are used to indicate that an item, condition or step being referred to is an optional (not required) feature of the invention.

The singular forms “a”, “an”, and “the” include the plural reference unless the context clearly dictates otherwise. The term “and/or” means any one of the items, any combination of the items, or all of the items with which this term is associated. The phrase “one or more” is readily understood by one of skill in the art, particularly when read in context of its usage.

The term “about” can refer to a variation of ±5%, ±10%, ±20%, or ±25% of the value specified. For example, “about 50” percent can in some embodiments carry a variation from 45 to 55 percent. For integer ranges, the term “about” can include one or two integers greater than and/or less than a recited integer at each end of the range. Unless indicated otherwise herein, the term “about” is intended to include values and ranges proximate to the recited range that are equivalent in terms of the functionality of the composition, or the embodiment.

As will be understood by one skilled in the art, for any and all purposes, particularly in terms of providing a written description, all ranges recited herein also encompass any and all possible sub-ranges and combinations of sub-ranges thereof, as well as the individual values making up the range, particularly integer values. A recited range includes each specific value, integer, decimal, or identity within the range. Any listed range can be easily recognized as sufficiently describing and enabling the same range being broken down into at least equal halves, thirds, quarters, fifths, or tenths. As a non-limiting example, each range discussed herein can be readily broken down into a lower third, middle third and upper third, etc.

As will also be understood by one skilled in the art, all language such as “up to”, “at least”, “greater than”, “less than”, “more than”, “or more”, and the like, include the number recited and such terms refer to ranges that can be subsequently broken down into sub-ranges as discussed above. In the same manner, all ratios recited herein also include all sub-ratios falling within the broader ratio.

1. A system for capturing and distributing a live audio or multi-media stream of a live event in real-time to a plurality of mobile computing devices, the system comprising:
a first memory device configured to store first computer-executable instructions, a first processing device coupled to the first memory device and at least one audio or multi-media input device configured to receive the live audio or multi-media stream;
a second memory device configured to store second computer-executable instructions and a second processing device coupled to the second memory device, the second processing device being in remote communication with the first processing device;
a third memory device configured to store third computer-executable instructions and a third processing device coupled to the third memory device, the third processing device being remote from the first processing device;
the first computer-executable instructions when executed by the first processing device causes the first processing device to:
receive the live audio or multi-media stream via the at least one audio or multi-media input device, and
transmit, over a first network, the received live audio or multi-media stream for receipt by the second processing device;
the second-computer executable instructions when executed by the second processing device causes the second processing device to:
upon receipt of the live audio or multi-media stream from the first processing device,
generate, in-real time, a plurality of discrete audio or multi-media data packets from the live audio or multi-media stream,
generate a transmission copy of each one of the plurality of discrete audio or multi-media data packets, and
transmit the transmission copies one-at-a time for receipt by the third processing device;
wherein the third-computer executable instructions when executed by the third processing device causes the third processing device to:
as each transmission copy is received, transmit that received transmission copy over a second network for receipt by the plurality of mobile computing devices prior to transmitting another received transmission copy for receipt by the plurality of mobile computing devices.

2. The system of claim 1, wherein the second network is a cellular carrier network comprising an LTE, a 4G, a 5G or a 6G network.

3. (canceled)

4. The system of claim 1, wherein the second processing device is part of a multi-access edge computing platform associated with the second network.

5. The system of claim 4, wherein the second processing device is an edge node of the second network.

6. The system of claim 1, wherein the first computer-executable instructions when executed by the first processing device further causes the first processing device to:
encode the received live audio or multi-media stream in accordance with User Datagram Protocol (UDP) prior to transmission to the second processing device.

7. The system of claim 1, wherein the second processing device is in network communication with a plurality of ancillary processing devices via an ancillary network and transmission of the transmission copies comprises:
via the ancillary network, internally distributing each transmission copy among the plurality of ancillary processing devices by the second processing device, wherein the internal distribution is performed in accordance with broadcast, multicast or unicast transmission protocols; and
transmitting, from the plurality of ancillary processing devices, the transmission copies one-at-a-time for receipt by the third processing device.

8. (canceled)

9. The system of claim 1, wherein the second computer-executable instructions when executed by the second processing device further causes the second processing device to:
prior to transmitting the transmission copies to the third processing device:
place each discrete audio data packet of the plurality of discrete audio data packets in a buffer and generate the transmission copy of each, wherein the transmission copies are generated from the discrete audio data packets placed in the buffer; and
as each discrete audio data packet is generated, retrieve the respective transmission copy from the buffer for transmission to the third processing device.

10. The system of claim 9, wherein the second processing device is enabled to retrieve and transmit the transmission copy of each discrete audio data packet from the buffer before that transmission copy is overwritten by a transmission copy of a next discrete audio data packet generated from the live audio or multi-media stream is placed in the buffer.

11. The system of claim 9, wherein the buffer is configured to store a single one of the discrete audio data packets.

12. The system of claim 1, wherein the second computer-executable instructions when executed by the second processing device further cause the second processing device to, for each discrete audio data packet:
generate a header comprising a packet sequence number associated with the transmission copy of that discrete audio data packet and a unique identifier associated with a respective one of the plurality of mobile computing devices; and
add the header with the transmission copy of that discrete audio data packet, prior to transmitting that transmission copy to the third processing device.

13. The system of claim 1, wherein the plurality of mobile computing devices have subscribed to the live audio or multi-media stream.

14. The system of claim 1, wherein the time from receiving the live audio or multi-media stream via the at least one audio or multi-media input device to the transmission of each one of the transmission copies to the plurality of mobile computing devices is in the range of: about near-zero milliseconds (mS) to about 25 mS, or about near-zero mS to about 100 mS, or about 100 mS to about 500 mS, or about 500 mS or less.

15. A system comprising:
a first subsystem comprising:
a first memory device configured to store first computer-executable instructions, a first processing device coupled to the first memory device and at least one first audio or multi-media input device configured to receive a first live audio or multi-media stream;
a second memory device configured to store second computer-executable instructions and a second processing device coupled to the second memory device, the second processing device being in remote communication with the first processing device;
a third memory device configured to store third computer-executable instructions and a third processing device coupled to the third memory device, the third processing device being remote from the first processing device;
the first computer-executable instructions when executed by the first processing device causes the first processing device to:
receive the first live audio or multi-media stream via the at least one first audio or multi-media input device, and
transmit, over a first network, the received first live audio or multi-media stream for receipt by the second processing device;
the second-computer executable instructions when executed by the second processing device causes the second processing device to:
upon receipt of the first live audio or multi-media stream from the first processing device,
generate, in-real time, a first plurality of discrete audio or multi-media data packets from the first live audio or multi-media stream,
generate a first transmission copy of each one of the plurality of first discrete audio or multi-media data packets, and
transmit the first transmission copies one-at-a time for receipt by the third processing device;
wherein the third-computer executable instructions when executed by the third processing device causes the third processing device to:
as each first transmission copy is received, transmit that received first transmission copy over a second network for receipt by a first plurality of mobile computing devices prior to transmitting another received first transmission copy for receipt by the first plurality of mobile computing devices; and
a second subsystem comprising:
a fourth memory device configured to store fourth computer-executable instructions, a fourth processing device coupled to the fourth memory device and at least one second audio or multi-media input device configured to receive a second live audio or multi-media stream;
a fifth memory device configured to store fifth computer-executable instructions and a fifth processing device coupled to the fifth memory device, the fifth processing device being in remote communication with the fourth processing device;
a sixth memory device configured to store sixth computer-executable instructions and a sixth processing device coupled to the sixth memory device, the sixth processing device being remote from the fourth processing device;
the fourth computer-executable instructions when executed by the fourth processing device causes the fourth processing device to:
receive the second live audio or multi-media stream via the at least one second audio or multi-media input device, and
transmit, over a fourth network, the second received live audio or multi-media stream for receipt by the fifth processing device;
the fifth-computer executable instructions when executed by the fifth processing device causes the fifth processing device to:
upon receipt of the second live audio or multi-media stream from the fourth processing device,
generate, in-real time, a second plurality of discrete audio or multi-media data packets from the second live audio or multi-media stream,
generate a second transmission copy of each one of the second plurality of discrete audio or multi-media data packets, and
transmit the second transmission copies one-at-a time for receipt by the sixth processing device;
wherein the sixth-computer executable instructions when executed by the sixth processing device causes the sixth processing device to:
as each second transmission copy is received, transmit that received second transmission copy over a fifth network for receipt by the plurality of mobile computing devices prior to transmitting another received second transmission copy for receipt by the second plurality of mobile computing devices, wherein the second subsystem is in communication with the first subsystem.

16. A system for distributing a live audio or multi-media stream of a live event in real-time to a plurality of mobile computing devices, the system comprising:
a memory device configured to store computer-executable instructions and a processing device coupled to the memory device, the computer-executable instructions when executed by the processing device causes the processing device to:
upon receipt, via a first network, of the live audio or multi-media stream from at least one audio device remote from the processing device,
generate, in-real time, a plurality of discrete audio data packets from the live audio or multi-media stream,
generate a transmission copy of each one of the plurality of discrete audio data packets, and
transmit the transmission copies one-at-a time to a provider processing device;
wherein the provider processing device is configured to, in accordance with a transmission policy associated with the provider processing device:
as each transmission copy is received, transmit that received transmission copy over a provider network for receipt by the plurality of mobile computing devices prior to transmitting another received transmission copy.

17. The system of claim 16, wherein the provider network is a cellular carrier network comprising an LTE, a 4G, a 5G or a 6G network.

18. (canceled)

19. The system of claim 16, wherein the processing device is part of a multi-access edge computing platform associated with the provider network.

20. The system of claim 19, wherein the processing device is an edge node of the provider network.

21. A method for capturing and distributing a live audio or multi-media stream of a live event in real-time to a plurality of mobile computing devices, the method comprising:
at a first processing device:
receiving, in real-time, the live audio or multi-media stream from at least one audio or multi-media input device, the first processing device being in remote communication with the at least one audio or multi-media input device;
generating, in real-time, a plurality of discrete audio or multi-media data packets from the live audio or multi-media stream;
generating a transmission copy of each one of the plurality of discrete audio or multi-media data packets, and
transmitting the transmission copies one-at-a-time for receipt by a second processing device; and
at the second processing device:
as each transmission copy is received, transmitting that received transmission copy over a network for receipt by the plurality of mobile computing devices prior to transmitting another received transmission copy for receipt by the plurality of mobile computing devices.

22. The method of claim 21, wherein the network is a cellular carrier network comprising an LTE, a 4G, a 5G or a 6G network.

23. (canceled)

24. The method of claim 21, wherein the first processing device is part of a multi-access edge computing platform associated with the network.

25. The method of claim 24, wherein the first processing device is an edge node of the network.

26. A non-transitory computer-readable medium for capturing and distributing a live audio or multi-media stream of a live event in real-time to a plurality of mobile computing devices, the computer-readable medium comprising computer-executable instructions for:
at a first processing device:
receiving, in real-time, the live audio or multi-media stream from at least one audio or multi-media input device, the first processing device being in remote communication with the at least one audio or multi-media input device;
generating, in real-time, a plurality of discrete audio or multi-media data packets from the live audio or multi-media stream;
generating a transmission copy of each one of the plurality of discrete audio or multi-media data packets, and
transmit the transmission copies one-at-a-time for receipt by a second processing device; and
at the second processing device:
as each transmission copy is received, transmit that received transmission copy over a network for receipt by the plurality of mobile computing devices prior to transmitting another received transmission copy for receipt by the plurality of mobile computing devices.

27. (canceled)

28. A system for capturing and distributing a live audio or multi-media stream of a live event in real-time to a plurality of mobile computing devices, the system comprising:
a processing device coupled to a memory device configured to store computer-executable instructions; and
a streaming module in communication with the processing device, the streaming module configured to:
receive the live audio or multi-media stream, or data indicative thereof,
generate, in-real time, a plurality of discrete audio or multi-media data packets from the live audio or multi-media stream,
generate a transmission copy of each one of the plurality of discrete audio or multi-media data packets, and
transmit the transmission copies one-at-a time for receipt by the processing device;
wherein the computer executable instructions when executed by the processing device cause the processing device to, as each transmission copy is received, transmit that received transmission copy over a network for receipt by the plurality of mobile computing devices prior to transmitting another received transmission copy for receipt by the plurality of mobile computing devices.

29. The system of claim 28, wherein the second network is a cellular carrier network.

30. The system of claim 29, wherein the second network is an LTE, a 4G, a 5G or a 6G network.

31. The system of claim 28, wherein the streaming module is part of a multi-access edge computing platform associated with the network.

32. The system of claim 31, wherein the streaming module is an edge node of the second network.

33. The system of claim 28, wherein the streaming module is further configured to encode the received live audio or multi-media stream in accordance with User Datagram Protocol (UDP) prior to transmission to the processing device.

34. A method for establishing User Datagram Protocol (UDP) communication between a client processing device associated with a first network and a processing device associated with a second network, the method comprising:
transmitting from the client processing device a generic UDP data packet via a network routing device, wherein the generic UDP data packet is associated with a first source network identifier;
upon receipt of the generic UDP data packet by the network routing device:
generating an updated generic UDP data packet by changing the first source network identifier to a second source network identifier,
generating a map of the first source network identifier to the second source network identifier using Network Address Translation (NAT), and
transmitting, for receipt by the processing device, the updated generic UDP data packet;
at the processing device,
receiving the updated generic UDP data packet, and
reading the second source network identifier;
transmitting at least one data packet from the processing device to the client processing device via the network routing device in accordance with the second source network identifier, wherein upon receipt of the at least one data packet, the network routing device translates the second source network identifier to the first source network identifier in accordance with the map and transmits the at least one data packet in accordance with the first source network identifier.

35. The method of claim 34, wherein the first source network identifier comprises at least one of a first source port identifier and a first source IP address.

36. The method of claim 34, wherein the second source network identifier comprises at least one of a second source port identifier and a second source IP address.

37. The method of claim 34, further comprising:
prior to transmitting the generic UDP data packet from the client processing device,
transmitting a Transmission Control Protocol (TCP) request for data from the client processing device to the processing device via the network routing device.

38. (canceled)

39. The method of claim 34, further comprising:
prior to transmitting the generic UDP data packet from the client processing device, opening a source port for UDP data traffic at the network routing device.

40. The method of any claim 34, wherein the first network is a private network and the second network is a public network.

41. The method of claim 40, wherein the private network is a cellular carrier network and the cellular carrier network is an LTE, a 4G, 5G or 6G network.

42. (canceled)

43. A system for establishing User Datagram Protocol (UDP) communication between computing devices, the system comprising:
a client processing device associated with a first network;
a processing device associated with a second network;
a network routing device comprising a network routing processing device coupled to a memory device configured to store network routing device computer-executable instructions, the network routing device computer-executable instructions when executed cause the network routing processing device to:
receive, from the client processing device, a generic UDP data packet associated with a first source network identifier;
generate an updated generic UDP data packet by changing the first source network identifier to a second source network identifier;
generate a map of the first source network identifier to the second source network identifier using Network Address Translation (NAT);
transmit, for receipt by the processing device, the updated generic UDP data packet;
receive, from the processing device, at least one data packet transmitted in accordance with the second source network identifier;
translate the second source network identifier to the first source network identifier in accordance with the map; and
transmit the received at least one data packet for receipt by the client processing device in accordance with the first source network identifier.

44. The system of claim 43, wherein the first source network identifier comprises at least one of a first source port identifier and a first source IP address.

45. The system of claim 43, wherein the second source network identifier comprises at least one of a second source port identifier and a second source IP address.

46. The system of claim 43, wherein the processing device is coupled to a processing memory device configured to store processing device computer-executable instructions that when executed causes the processing device to, prior to the receipt of the at least one data packet transmitted in accordance with the second source network identifier:
receive the updated generic UDP data packet;
read the second source network identifier from the updated generic UDP data packet; and
generate the at least one data packet associated with the second source network identifier.

47. The system of claim 43, wherein the client processing device is coupled to a client memory device configured to store client device computer-executable instructions that when executed causes the client processing device to:
transmit a TCP request for data to the processing device via the network routing processing device prior to the transmission of the generic UDP data packet.

48. The system of any claim 43, wherein the first network is a private network and the second network is a public network.

49. The system of claim 43, wherein the first network is a cellular carrier network comprising an LTE, a 4G, 5G, or 6G network.

50. (canceled)

51. The system of claim 43 wherein the processing device does not have administrative control over the network routing device.

52. A non-transitory computer-readable medium for establishing User Datagram Protocol (UDP) communication between a client processing device associated with a first network and a processing device associated with a second network, the computer-readable medium comprising computer executable instructions for:
transmitting from the client processing device a generic UDP data packet via a network routing device, wherein the generic UDP data packet is associated with a first source network identifier;
upon receipt of the generic UDP data packet by the network routing device:
generating an updated generic UDP data packet by changing the first source network identifier to a second source network identifier,
generating a map of the first source network identifier to the second source network identifier using Network Address Translation (NAT), and
transmitting, for receipt by the processing device, the updated generic UDP data packet;
at the processing device,
receiving the updated generic UDP data packet, and
reading the second source network identifier;
transmitting at least one data packet from the processing device to the client processing device via the network routing device in accordance with the second source network identifier, wherein upon receipt of the at least one data packet, the network routing device translates the second source network identifier to the first source network identifier in accordance with the map and transmits the at least one data packet in accordance with the first source network identifier.

53. (canceled)
